(19) United States
(12) Patent Application Publication
(10) Pub. No.: US 2013/0289977 A1
(43) Pub. Date: Oct. 31, 2013

(54) INFORMATION PROCESSING DEVICE, INFORMATION PROCESSING METHOD, AND PROGRAM

(71) Applicant: SONY CORPORATION, Tokyo (JP)

(72) Inventors: Yu TANAKA, Tokyo (JP); Yohei KAWAMOTO, Tokyo (JP); Koichi SAKUMOTO, Tokyo (JP); Kazuya KAMIO, Tokyo (JP); Taizo SHIRAI, Kanagawa (JP)

(73) Assignee: SONY CORPORATION, Tokyo (JP)

(21) Appl. No.: 13/848,236

(22) Filed: Mar. 21, 2013

(30) Foreign Application Priority Data
Apr. 27, 2012 (JP) 2012103553

(51) Int. Cl. G06F 17/22

(52) U.S. Cl. CPC G06F 17/22
USPC 704/9

(57) ABSTRACT

There is provided an information processing device including an acquisition unit that acquires a first word input by a user, and a presentation unit that presents second words for replacing the first word when the first word is acquired by the acquisition unit.

### BACKGROUND

The present technology relates to an information processing device, an information processing method, and a program, and more particularly, to an information processing device, an information processing method, and a program that can present abstract words suitable for protecting privacy information.

In recent years, various services have been provided through the Internet, and users have come to use such services with ease. As the provided services, there are services referred to as blogs, social networking services (SNSs), and twitter (registered trademark), so that a very large amount of information is delivered by users through these microblogs.

On the other hand, there are cases in which a user's privacy information is leaked among content disclosed by the user. There is a necessity of technology for preventing such leakage of privacy caused by careless posting or sentence disclosure of a user, particularly, on an individual basis. For such a necessity, technology for preventing the leakage of users' privacy is being proposed.

For example, Japanese Unexamined Patent Application Publication No. 2009-199385 proposes specifying privacy information in a document written by a user, and masking the corresponding portion (removing or replacing the corresponding portion with a symbol). The detailed sequence will be briefly mentioned. First, a disclosed document is provided from a client of a user side to a file server. The file server detects and masks personal information by using two methods, and stores the personal information in a file database.

In the first personal information detection method of the two personal information detection methods, documents are searched using a private information dictionary in which privacy information has been defined, and thereby it is searched whether the corresponding words are included in the documents. In a second detection method, a noun extracted from processed documents is used in an external search server to carry out a search, and the search result is specified as personal information when a hit rate of the search result is a threshold value that has been determined in advance by a user or less.

Japanese Patent Application No. 2011-018009 proposes signaling privacy information in a document written by a user, leaving a determination to the user, and thereby prompting the user not to mask but to rewrite the corresponding portion. The detailed sequence will be briefly mentioned. First, a disclosed document is provided from a client of a user side to a file server. The file server estimates personal information using two kinds of user dictionaries, and presents the personal information to the user, thereby causing the user to make a determination. Then, according to the determination of the user, the user dictionaries are updated.

As the two kinds of user dictionaries, a white list and a black list are prepared. The white list is a list in which the estimation result of the file server is recorded when the estimation result is not determined to be personal information. The black list is a list in which the estimation result of the file server is recorded when the estimation result is determined to be personal information.

Japanese Unexamined Patent Application Publication No. 2005-190389 proposes technology that has a purpose of preventing a user's privacy information from being displayed in a predictive text string displayed when a user inputs text, Japanese Unexamined Patent Application Publication No. 2005-190389 proposes determining whether to register a text string determined to be input by a user with a database by switching between a privacy-unprotected mode and a privacy-protected mode, and thereby preventing a text string that is unfavorable for the user from being recorded in the database.

### SUMMARY

When a statement related to privacy is made to prevent the leakage of privacy by masking or replacing a random word as described above, there is a probability that the meaning of a sentence will be corrupted. Also, in the case of masking, there is a risk that a masked portion will clearly tell the presence of a privacy problem to other users.

The present technology is desirable to enable prevention of the leakage of privacy without corrupting the meaning of a sentence.

According to an embodiment of the present disclosure, there is provided an information processing device including an acquisition unit that acquires a first word input by a user, and a presentation unit that presents second words for replacing the first word when the first word is acquired by the acquisition unit.

The second words may be words obtained by abstracting the first word.

The second words may be displayed and presented to the user between a first item manipulated when the first word is used without being replaced and a second item manipulated when a third word different from the first word and the second words is used.

The first item, the second words, and the second item may be displayed in a speech balloon, and a tail of the speech balloon is positioned near the first word.

When the first word has been registered in a database in which the plurality of second words are connected with the first word, the second words may be read out and presented to the user.

When presentation of the second words related to the first word is instructed by the user, the second words may be presented.

When a text string is input, and the text string is converted into the first word, the second words may be presented.

When the first word is selected from a group of words presented by predicting words to be input from input text, the second words may be presented.

When words to be input are predicted from input text, and the first word is included in the predicted words, the second words may be presented by displaying the second words to be connected with the first word in a group of predicted words.

When text is input, words to be input are predicted from the text, a group of the predicted words is presented, and a cursor is positioned on the first word in the presented group of words, the second words may be presented.

The information processing device may further include an update unit that updates the database in which the plurality of second words is connected with the first word when the second words are selected, or a third word is input. The update unit may update a weight indicating a frequency of use of the second words when the second words are selected, and add the third word as the second words when the third word is input.

The second words may be connected with the first word in a state in which the second words are lined up in descending or ascending order of value calculated according to a predetermined operation expression, and managed in the database.

The value may be a value indicating a degree of abstraction of a word.

The database may be updated and compiled by carrying out a search in which a fourth word serving as the first word is set as a search target, randomly extracting a word from a page obtained as a search result, classifying the extracted word according to whether the extracted word includes the fourth word or whether the fourth word is included, and adding a classification result to the database.

According to an embodiment of the present disclosure, there is provided an information processing method of an information processing device including an input unit that receives an input of a user, and a presentation unit that presents information to the user, the method including acquiring a first word input through the input, unit by the user, and when the first word is acquired, presenting second words for replacing the first word by the presentation unit.

According to an embodiment of the present disclosure, there is provided a computer-readable program causing a computer controlling an information processing device including an input unit that receives an input of a user, and a presentation unit that presents information to the user to perform a process including acquiring a first word input through the input unit by the user, and when the first word is acquired, presenting second words for replacing the first word by the presentation unit.

In an information processing device, an information processing method, and a program of an aspect of the present technology, when a first word input by a user is acquired, a second word for replacing the first word is presented to the user, and thereby replacement is prompted.

According to an aspect of the present technology, it becomes possible to prevent the leakage of privacy without corrupting the meaning of a sentence.

### BRIEF DESCRIPTION OF THE DRAWINGS

FIG. 1 is a diagram showing a configuration of an embodiment of an information processing system to which the present technology is applied;

FIG. 2 is a diagram showing an example of a configuration of an input support server;

FIG. 3 is a diagram showing an example of a configuration of a client;

FIG. 4 is a diagram illustrating input support;

FIG. 5 is a diagram illustrating a timing of input support;

FIG. 6 is a diagram illustrating a timing of input support;

FIG. 7 is a diagram illustrating a timing of input support;

FIG. 8 is a diagram illustrating a timing of input support;

FIG. 9 is a diagram illustrating a timing of input support;

FIG. 10 is a flowchart illustrating a process of a client;

FIG. 11 is a flowchart illustrating a process of an input support server;

FIGS. 12A and 12B are diagrams illustrating a word dictionary database;

FIG. 13 is a flowchart illustrating word dictionary database search process 1;

FIG. 14 is a diagram illustrating a word dictionary database;

FIG. 15 is a diagram illustrating a word dictionary database;

FIG. 16 is a flowchart illustrating word dictionary database search process 2;

FIG. 17 is a flowchart illustrating word dictionary database search process 3;

FIG. 18 is a flowchart illustrating word dictionary database search process 4;

FIG. 19 is a flowchart illustrating an update process;

FIG. 20 is a flowchart illustrating an abstraction level calculation process;

FIG. 21 is a diagram illustrating a word dictionary database;

FIG. 22 is a diagram illustrating an abstraction level;

FIG. 23 is a diagram illustrating a word dictionary database;

FIG. 24 is a diagram illustrating a word dictionary database;

FIG. 25 is a diagram illustrating a word dictionary database;

FIG. 26 is a diagram illustrating a word dictionary database;

FIG. 27 is an example of a screen presented when a word dictionary database is compiled;

FIG. 28 is a flowchart illustrating a process related to compilation of a word dictionary database; and

FIG. 29 is a diagram showing a configuration of a personal computer.

### DETAILED DESCRIPTION OF THE EMBODIMENT(S)

Hereinafter, preferred embodiments of the present technology will be described in detail with reference to the appended drawings. Note that, in this specification and the appended drawings, structural elements that have substantially the same function and structure are denoted with the same reference numerals, and repeated explanation of these structural elements is omitted.

Hereinafter, a mode for implementing the present technology (hereinafter referred to as an embodiment) will be described. Description will be given in the following order.

1. Regarding Configuration of Information Processing System

2. Regarding Configuration of Each Device Constituting Information Processing System

3. Regarding Process Related to Input Support

4. Regarding Update of Database Referred to When Process Related to Input Support Is Performed

5. Regarding Compilation of Database

[Regarding Configuration of Information Processing System]

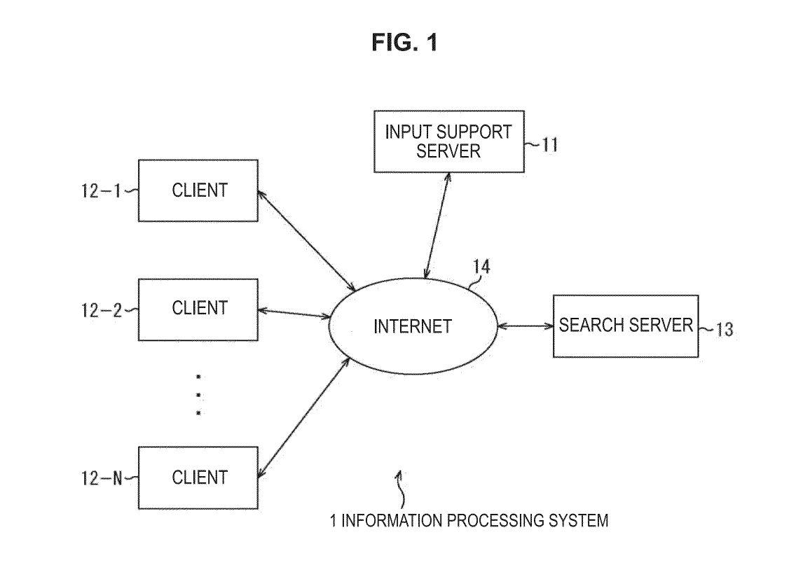

FIG. 1 is a diagram showing an example of a configuration of an embodiment of an information processing system 1 to which the present technology is applied.

The information processing system 1 of FIG. 1 includes an input support server 11, clients 12-1 to 12-N (N is a natural number), a search server 13, and the Internet 14.

When it is not necessary to distinguish the clients 12-1 to 12-N from one another, the clients 12-1 to 12-N are simply referred to as the clients 12. This is the same for other components.

The input support server 11, the clients 12, and the search server 13 are connected through the Internet 14. The Internet 14 can be used together with or instead of various wired and/or wireless networks.

Here, it is preferred to protect a communication path between the input support server 11 and the clients 12 by using an existing encryption technology such as SSL (Secure Socket Layer) or the like.

[Regarding Configuration of Each Device Constituting Information Processing System]

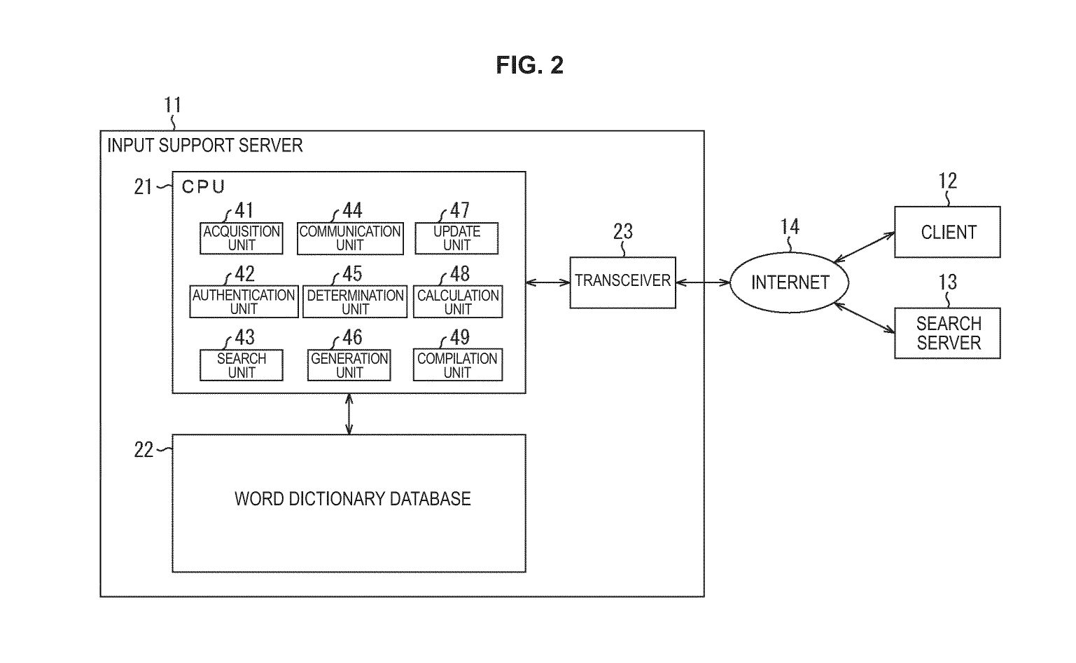

FIG. 2 is a diagram showing an example of a configuration of the input support server 11 that is an information processing device. The input support server 1 has a CPU (Central Processing Unit) 21, a word dictionary database 22, and a transceiver 23.

The CPU 21 has function blocks of an acquisition unit 41, an authentication 42, a search unit 43, a communication unit 44, a determination unit 45, a generation unit 46, an update unit 47, a calculation unit 48, and a compilation unit 49. The respective blocks of the CPU 21 can exchange signals and data with each other according to necessity.

The acquisition unit 41 acquires various kinds of information. The authentication unit 42 authenticates the clients 12. The search unit 43 searches for various kinds of information. The communication unit 44 communicates various kinds of information. The determination unit 45 determines various kinds of information. The generation unit 46 generates edited content. The update unit 47 updates various kinds of information. The calculation unit 48 calculates an abstraction level. The compilation unit 49 compiles the word dictionary database 22.

The word dictionary database 22 is a database including data in which a plurality of words are connected with one word as will be described later. The transceiver 23 transmits and receives various kinds of information to and from the clients 12 and the search server 13 through the Internet 14.

[Configuration of Client 12]

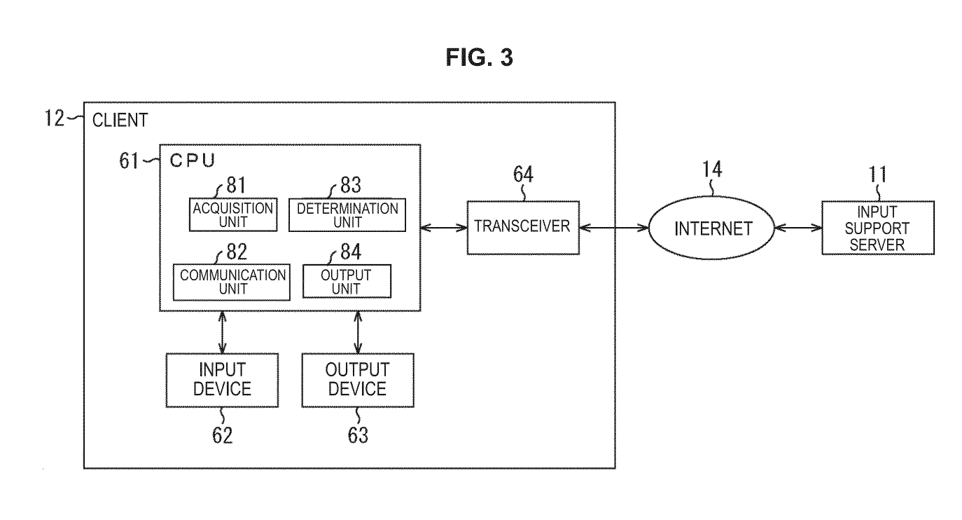

FIG. 3 is a block diagram showing an example of a configuration of a client 12 that is an information processing device. The client 12 has a CPU (Central Processing Unit) 61, an input device 62, an output device 63, and a transceiver 64.

The CPU 61 has function blocks of an acquisition unit 81, a communication unit 82, a determination unit 83, and an output unit 84. The respective blocks of the CPU 61 can exchange signals and data with each other according to necessity.

The acquisition unit 81 acquires various kinds of information. The communication unit 82 communicates various kinds of information. The determination unit 83 determines various kinds of information. The output unit 84 outputs various kinds of information.

The input device 62 includes a user interface such as a camera, a keyboard, a mouse, and the like, and is manipulated by a user when predetermined information is input. The output device 63 includes, for example, a display, a speaker, or the like that outputs an image or music. The transceiver 64 transmits and receives various kinds of information to and from the input support server 11 through the Internet 14.

[Regarding Input Support]

Next, a process related to input support performed in the information processing system 1 will be described. Input support means presenting a word for a substitution expression and the like by, when information related to privacy is included in content such as text and the like input from the side of the client 12, or in similar eases, notifying a user that information related to privacy is included by means of the input support server 11.

In description below, a case in which text is input, and when a word in the text (sentence) is related to privacy, the word is replaced with an abstract word will be described by way of example. However, the present technology is not only, applied to text, but also can be applied to other content, for example, an image or the like by performing an appropriate process for data of the other content.

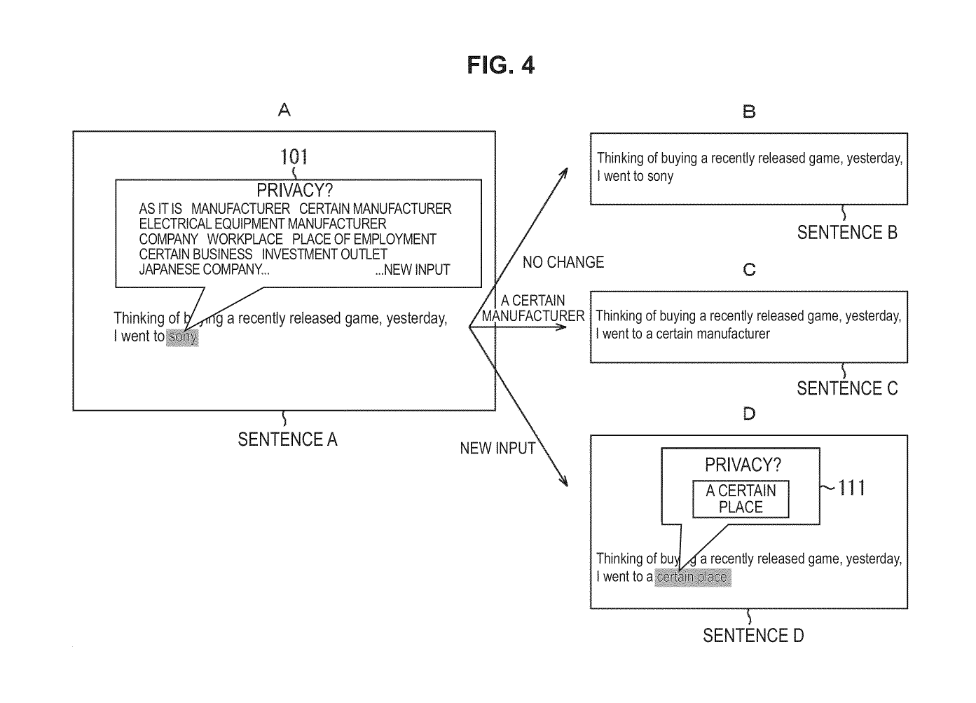

Here, input support will be described with reference to FIG. 4. It is assumed that a user inputs a sentence shown as sentence A of FIG. 4 by manipulating the input device 62, of the client 12. Sentence A is displayed on a display used as the output device 63.

Sentence A is in a state in which an input has been made up to “Thinking of buying a recently released game, yesterday, I went to sony”. Although sony is a registered trademark, one point of the present disclosure is to replace such a word with an abstract word, and thus description will continue using the name “sony”.

At a point in time when the word “sony” is input while such sentence A is being input, a speech balloon 101 is displayed as shown in FIG. 4. In the speech balloon 101, words “No change,” “a manufacturer,” “a certain manufacturer,” “an electrical equipment manufacturer,” “a company,” “a workplace,” “a place of employment,” “a certain corporation,” “an investment outlet,” “a Japanese company,” and “New input” are displayed under the expression “Privacy?”

Also, as shown in FIG. 4A, a tail of the speech balloon 101 is displayed to be positioned above the word “sony” that is considered as a process target. Here, the tail of the speech balloon 101 is not only displayed above a process-target word, but may also be displayed under the word or at other positions, so that the speech balloon 101 itself may be displayed under the word. In other words, the tail of the speech balloon 101 may be displayed near a process-target word to readily cause a user to recognize that the speech balloon 101 is a speech balloon of the word.

Although description below including FIG. 4 will be made on the assumption that the speech balloon 101 is displayed, words may be displayed in a shape other than a speech balloon or displayed not in the form of a speech balloon but in the form of a menu such as a pull-down menu or the like, or a dedicated region may be installed, so that words may be displayed in the region.

The words displayed in the speech balloon 101 are words that become candidates for a case in which the word “sony” is replaced with another word. Also, the words displayed in the speech balloon 101 are words by which it is not possible identify the company name “sony”. For example, it is difficult to uniquely derive “sony” from the word “a manufacturer.” in this way, the words displayed in the speech balloon 101 are considered as words by which it is not possible to uniquely identify a word that is a replacement target.

As described above, as input support, support for replacing an input word with another abstract word is performed.

When the speech balloon 101 as shown in FIG. 4A is displayed, if the user selects the words “No change,” a sentence that has been input up to that point in time is determined to bc sentence B shown in FIG. 4B. In other words, sentence B is a sentence determined by using the word “sony” without replacing the word “sony” with another word.

When the speech balloon 101 as shown in FIG. 4A is displayed, and the user selects the words “a certain manufacturer,” a sentence that has been input up to that point in time is determined to be sentence C shown in FIG. 4C. In other words, sentence C is determined to be a sentence in which the word “sony” has been replaced with the words “a certain manufacturer.”

When the speech balloon 101 as shown in FIG. 4A is displayed, and the user selects the words “New input,” a new speech balloon 111 is displayed as shown in FIG. 4D. “New input” is an item selected when another word is input by the user. Thus, the speech balloon lii in which the user can input another word is displayed. In the speech balloon 111, a section for inputting another word is displayed, and configured so that the user can input a desired word to the section.

In the example shown in FIG. 4D, the user has input the words “a certain place” to the section in the speech balloon 111. In this case, sentence D is a sentence determined to be a sentence in which the word “sony” has been replaced with the words “a certain place.”

As described above, support in which the word “sony” specifying one company can be replaced with the words “a certain manufacturer” or “a certain place” by the user's intention is input support.

As described above with reference to FIG. 4, the words “No change” in the speech balloon 101 are an item that is selected when the word input by the user is used as it is, and do not mean that the word “sony” will be replaced with the words “No change.” Likewise, the words “New input” in the speech balloon 101 are an item that is selected when neither the word input by the user nor a word displayed in the speech balloon 101 is used, and do not mean that the word “sony” will be replaced with the words “New input.”

In comparison with the items “No change” and “New input,” the words “a manufacturer” or the words “a certain manufacturer” are displayed as candidates for replacing the word, and when the word(s) is selected, the word having been set as a replacement target is replaced with the selected word(s).

In this way, in the speech balloon 101, words that become replacement candidates are displayed between the item manipulated when an input word is used as it is and the item manipulated when another word is input. The words that become replacement candidates are lined up in order of high abstraction level. The abstraction level will be described later.

In addition, the timing of displaying the speech balloon 101 or the speech balloon 111 shown in FIG. 4 is an example, and the display timing varies according to a process of the input support server 11 and the client 12 related to the input support process. Here, description will be further made regarding the display timing.

[Regarding Timing of Performing Input Support]

Next, the timing of performing input support will be described. The timing of performing input support is, referring to FIG. 4 again, the timing of showing the speech balloon 101. The timing of showing the speech balloon 101 is a timing at which a process of steps S5 to S8 is performed in a process of the client 12 that will be described later, and a timing at which a process of steps S32 and S33 is performed in the input support server 11. In particular, description will be further made below regarding at which timing a process of transmitting content in step S6 will be performed by the client 12.

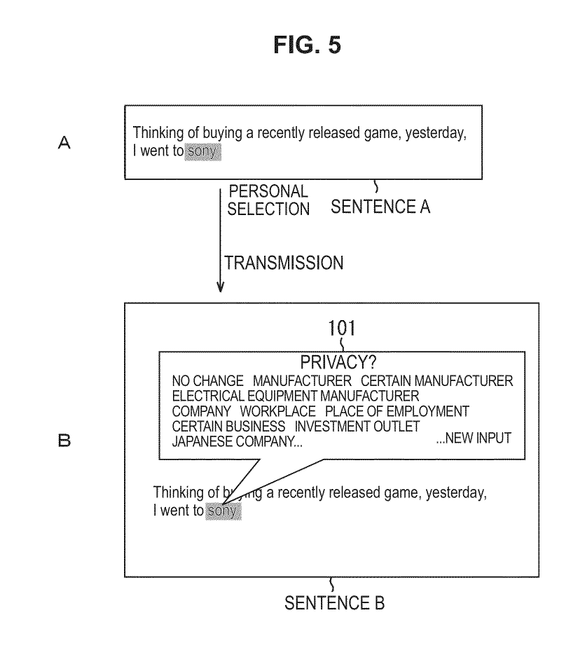

FIG. 5 is a diagram illustrating a first display timing. It is assumed that the user manipulates the input device 62 of the client 12 to input a sentence shown as sentence A in FIG. 5A. Sentence A is displayed on a display as the output device 63.

Sentence A shown in FIG. 5A is in a state in which an input has been made up to “Thinking of buying a recently released game, yesterday, I went to sony”. When such sentence A is input, and the word “sony” is selected by the user, the word “sony” is transmitted to the input support server 11 in response to the selection. The selection at this time means that the user has personally selected the word receiving input support.

As a result of such a transmission, by the input support server 11, words that will be displayed in the speech balloon 101 are searched in the word dictionary database 22. Here, a word string “a manufacturer,” “a certain manufacturer,” “an electrical equipment manufacturer,” “a company;” “a workplace,” “a place of employment,” “a certain corporation,” “an investment outlet,” and “a Japanese company” is read out from the word dictionary database 22.

Details will be described later, but presentation information including the read-out word string is generated in the input support server 11. In other words, in this case, an item “No change” and an item “New input” are added to the word string, and presentation information “No change,” “a manufacturer,” “a certain manufacturer,” “an electrical equipment manufacturer,” “a company,” “a workplace,” “a place of employment,” “a certain corporation,” “an investment outlet,” “a Japanese company,” and “New input”

is generated.

The generated presentation information is transmitted from the input support server 11 to the client 12. As a result, in the client 12, the presentation information from the input support server 11 is acquired, and output to an output device such as a display or the like.

FIG. 5B shows output presentation information. In other words, like in FIG. 4A, the speech balloon 101 pops up from the word “sony,” and presentation information is displayed in the speech balloon 101. In this way, transmission of a replacement-target word (content) is triggered by personal selection of a user, and the results are received, so that words for replacement are presented to the user.

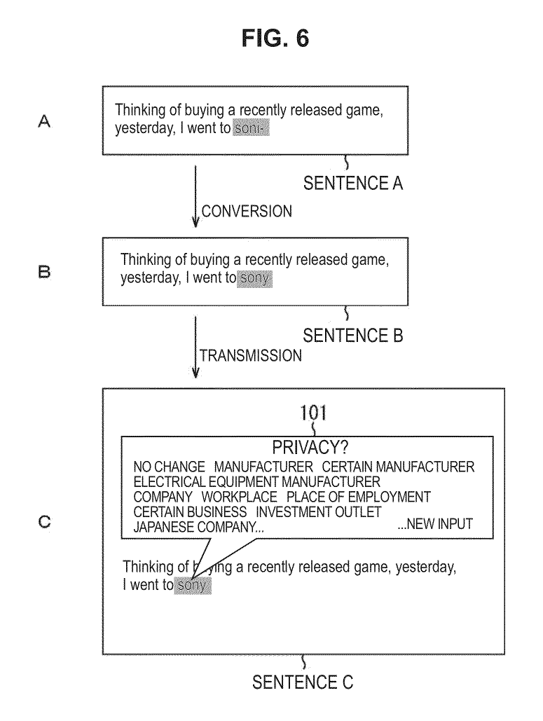

Next, a second display timing will be described with reference to FIG. 6. In description below, description that overlaps the first display timing described with reference to FIG. 5 will be properly simplified.

Sentence A shown in FIG. 6A is in a state in which an input has been made up to “Thinking of buying recently released game, yesterday, I went to soni-,” and is a sentence in a state before the word “soni-” is converted into the word “sony.” In general, in input of a sentence, “soni-” is input first in Japanese reading, and then converted into “sony.” Sentence A is in a state before the conversion.

Although an input is not necessarily provided in Japanese reading, a text string is input in Japanese reading and the like and then convened into a desired word in general. In other words, a process of conversion is frequently included in input of text.

When such a conversion is instructed, sentence A becomes sentence B “Thinking of buying recently released game, yesterday, I went to sony”. At this time, by using the conversion as a trigger, the converted word, that is, the word “sony” in this case, is transmitted from the client 12 to the input support server 11.

As a result, presentation information is transmitted from the input support server 11, acquired by the client 12, output to the output device 63, and thereby presented to the user. In other words, as shown in FIG. 6C, words that become replacement candidates are presented to the user with presentation information presented in the speech balloon 101. A state of sentence C shown in FIG. 6C is the same as that of sentence B shown in FIG. 5B. As described above, by using conversion as a trigger, a word that becomes a replacement target may be transmitted to the side of the input support server 1.

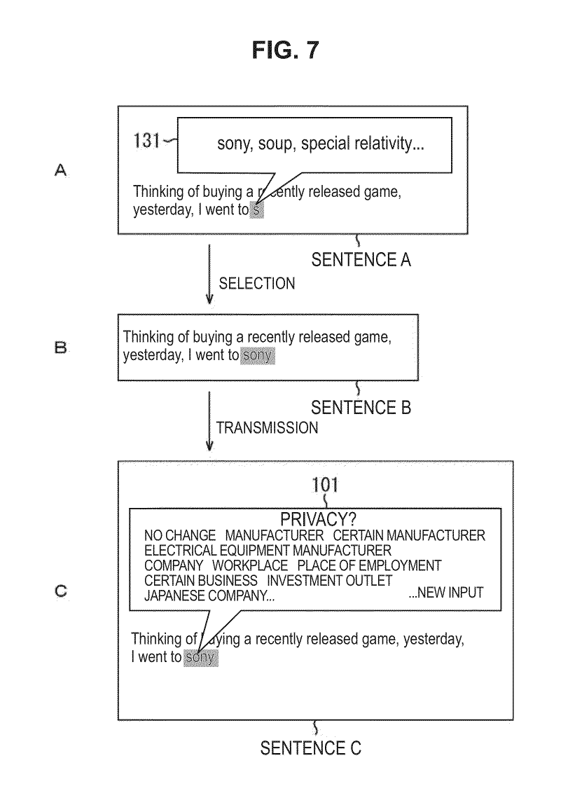

Next, a third display timing will be described with reference to FIG. 7. Sentence A shown in FIG. 7A is in a state in which an input has been made up to “Thinking of buying a recently released game, yesterday, I went to s”, and a speech balloon 131 pops up from the character “s.” There is a function that is referred to as predictive input, predictive conversion, or the like, and when a user inputs one character, the function predicts characters following the input character to suggest words.

In the example shown in FIG. 7A, in response to the input character “s”, the words “sony”, “soup”, and “special relativity” are displayed in the speech balloon 131 and presented to the user. From such a group of words displayed in the speech balloon 131, the user selects a word that he or she wants to input. Here, it is assumed that the word “sony” has been selected.

When such a selection is made, sentence A is considered as sentence B “Thinking of buying a recently released game, yesterday, I went to sony”. When a group of words is presented to the user in the form of, for example, the speech balloon 131 using such a prediction function, the user can input the word “sony” by inputting only “s”.

Using determination of a, word through such a selection from a group of words as a trigger, a converted word, that is, the word “sony” in this case, is transmitted from the client 12 to the input support server 11.

As a result, presentation information is transmitted from the input support server 11, acquired by the client 12, output to the output device 63, and thereby presented to the user. In other words, as shown in FIG. 7C, words that become replacement candidates are presented to the user with the presentation information presented in the speech balloon 101. A state of sentence C shown in FIG. 7C is the same as that of sentence B shown in FIG. 5B. As described above, by using selection of a word from a group of words presented by the prediction function as a trigger, a word that becomes a replacement target may be transmitted to the side of the input support server 11.

Here, comparison will be made between the words displayed in the speech balloon 131 shown in FIG. 7A and the words displayed in the speech balloon 101 shown in FIG. 7C. At least the first character of the words displayed in the speech balloon 131 is a character input by the user, so that the words begin with the character. In other words, the words displayed in the speech balloon 131 have the same first character in common. However, the words displayed in the speech balloon 131 often have no semantic relationship with each other.

On the other hand, words that do not have the character input by the user as the first character are also presented as the words displayed in the speech balloon 101. Thus, the words displayed in the speech balloon 101 do not have the same first character in common. However, the words displayed in the speech balloon 101 have a semantic relationship with each other. The semantic relationship is a relationship in which the words have the same meaning as or a similar meaning to a word that has become a target so as to be words suitable to be substituted for the word that has become a target.

Also, the words presented in the speech balloon 131 and the words presented in the speech balloon 101 present different intentions. One purpose of the words presented in the speech balloon 131 is to lighten the load of an input by reducing the number of characters input by the user.

On the other hand, the words presented in the speech balloon 101 are presented to the user when it is determined that it is preferable to replace the word input by the user with another word, for example, when the word input by the user is a word that may be related to privacy and determined to be inappropriate for release to the public by means of a blog or the like, and it is determined that it is preferable to replace the word with another word. Also, the presented words are words suitable for replacement, and one purpose of them is to lighten the load of a user necessary for a process of thinking and inputting a word for replacement.

As described above, the words presented in the speech balloon 131 and the words presented in the speech balloon 101 all support input of the user in common, but have different content and support methods. This is the same in the following description.

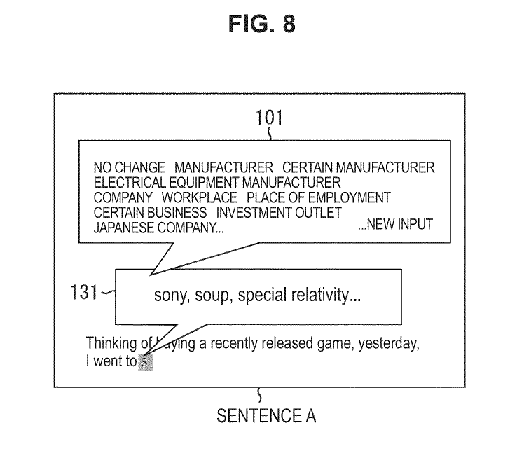

Next, a fourth display timing will be described with reference to FIG. 8. Sentence A shown in FIG. 8 is in a state in which an input has been made up to “Thinking of buying a recently released game, yesterday, I went to s”. This state is the same as that shown in FIG. 7A. While it has been illustrated in FIG. 7 that the speech balloon 101 is displayed after the speech balloon 131, the speech balloon 131 and the speech balloon 101 are simultaneously displayed in FIG. 8.

In other words, in the state of sentence A shown in FIG. 8, the speech balloon 131 pops up from the character “s”, and the speech balloon 101 is displayed for the word “sony” displayed in the speech balloon 131. In this way, when a word that becomes a replacement target is included in a group of words presented by predictive conversion, a group of words may be further presented by input support for the word that becomes a replacement target. In addition, when such a presentation is made, speech balloons may be displayed in two stages as shown in FIG. 8.

When a word that becomes a replacement target is presented as shown in FIG. 8, by using presentation of results of predictive conversion that is performed by a predictive conversion function on the character “s” input to sentence A as a trigger, the word “sony” is transmitted from the client 12 to the input support server 11.

As a result, presentation information is transmitted from the input support server 11, acquired by the client 12, output to the output device 63, and thereby presented to the user. In other words, as shown in FIG. 8, words that become replacement candidates are presented to the user with the speech balloon 101 displayed for the word “sony” in the speech balloon 131 when presentation information is presented in the speech balloon 101.

As described above, by using presentation of a group of words due to the prediction function as a trigger, a word that becomes a replacement target may be transmitted to the side of the input support server 11.

Words transmitted to the input support server 11 are considered to be a predetermined number of words that are displayed to be high rankings in a group of words presented by the prediction function. In this case, when the group of words is presented by the prediction function, for example, 3 words of high rankings are selected from the group of words and transmitted to the input support server 11. As a result, a process is performed on the 3 words by the input support server 11, and presentation information for the 3 words is generated and transmitted to the client 12.

In the example shown in FIG. 8, the one speech balloon 101 is shown, but when 3 pieces of presentation information are acquired, 3 speech balloons 101 are displayed to suggest the 3 pieces of presentation information to the user. When the 3 speech balloons 101 are displayed, the respective speech balloons 101 may be displayed not to overlap at the same time. Alternatively, in the speech balloon 131, a speech balloon 101 of a word at which a cursor (not shown) is positioned may be displayed on another speech balloon 101 to overlap the other speech balloon 101.

As described above, when the speech balloon 131 and the speech balloon 101 are simultaneously displayed, the user becomes able to replace a word that the user has wanted to input with another word by one manipulation.

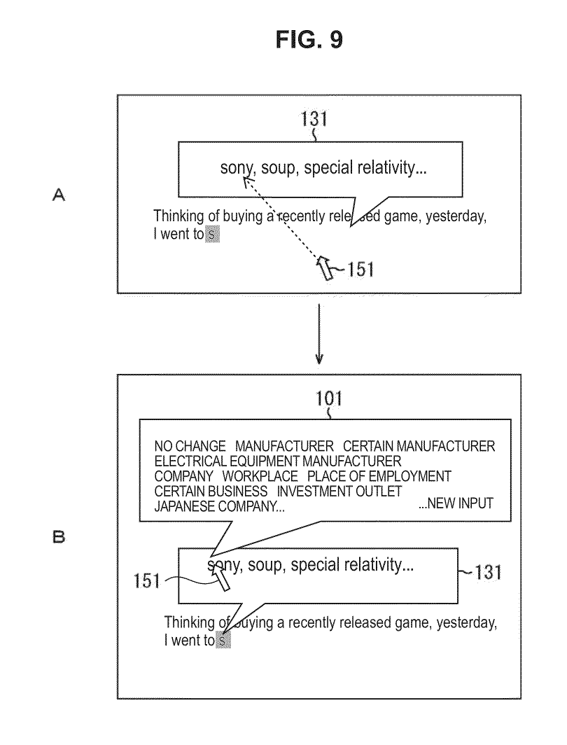

Next, a fifth display timing will be described with reference to FIG. 9. Sentence A shown in FIG. 9 is in a state in which an input has been made up to “Thinking of buying a recently released game, yesterday, I went to s”. This state is the same as that shown in FIG. 7A. In FIG. 7, it has been illustrated that the speech balloon 101 is displayed after the speech balloon 131, and in FIG. 9, the speech balloon 101 is likewise displayed after the speech balloon 131 but at a different timing.

In an example shown in FIG. 9A, the words “sony”, “soup”, and “special relativity” according to prediction are displayed for the input character “s” in the speech balloon 131 and presented to the user. One word in the group of words displayed in the speech balloon 131 is overlapped by a cursor 151. Here, it is assumed that the cursor 151 overlaps the word “sony”.

Using such an overlap of the cursor 151 as a trigger, the word overlapped by, the cursor 151, in this case, the word, “sony”, is transmitted from the client 12 to the input support server 11.

As a result, presentation information is transmitted from the input support server 11, acquired by the client 12, output to the output device 63, and thereby, presented to the user. This presentation can be made by displaying speech balloons in two stages as shown in FIG. 9B, like in FIG. 8. As described above, by using an overlap of a cursor on a predetermined word among a group of words presented by the prediction function as a trigger, a word that becomes a replacement target may be transmitted to the side of the input support server 11.

[Regarding Process Related to Input Support]

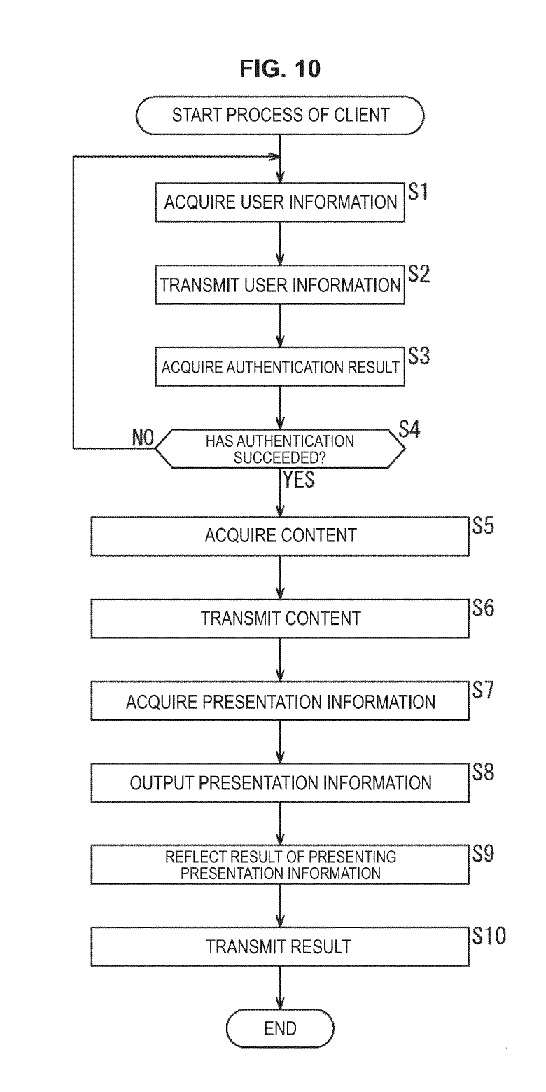

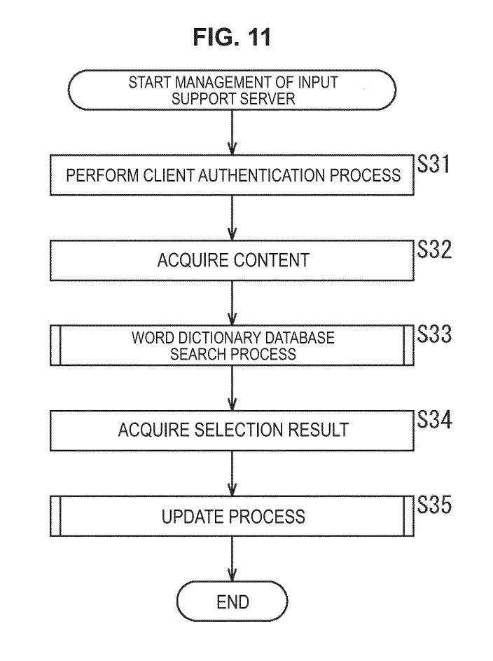

A process related to such input support is performed by the client 12 and the input support server 11. First, a process performed in the client 12 will be described with reference to a flowchart of FIG. 10, and a process performed in the input support server 11 will be described with reference to a flowchart of FIG. 11. Here, since the process of the input support server 11 is performed to correspond to the process of the client 12, description will be continuously made with reference to the respective flowcharts of FIG. 10 and FIG. 11.

In addition, although description continues on the assumption that the process related to input support is performed by the client 12 and the input support server 11, the process performed by the input support server 11 can also be performed by the client 12, and the process related to input support can also be configured to be performed by the client 12 alone.

For example, when the client 12 has the word dictionary database 22 and) is configured to be able to perform a process that is performed with reference to the word dictionary database 22, even the client 12 alone can perform a process related to input support described below.

In step S1 of FIG. 10, the acquisition S1 of the client 12 acquires user information through the input device 62. In other words, information that is represented by an ID, a password, and the like necessary for authentication and has been input by the user is acquired. In step S2, the communication unit 82 of the client 12 transmits the user information to the input support server 11 through the transceiver 64 and the Internet 14.

In step S31 of FIG. 11, the input support server 11 performs a client authentication process. The acquisition unit 41 of the input support server 11 acquires the user information through the Internet 14 and the transceiver 23. In other words, the user information transmitted through the process of step S2 of FIG. 10 is acquired. The acquired information is used in the authentication unit 42 to authenticate the client 12.

It is checked that the user is a user who has been registered in the input support server 11 in advance, and has a right to use a privacy information protection service provided by the input support server 11. In other words, it is checked whether the user is a user (client 12) who has a right to use the word dictionary database 22.

The determination unit 45 of the input support server 11 determines whether the authentication has succeeded, and when it is determined that the authentication has succeeded, the communication unit 44 of the input support server 11 notifies the client 12 of success in authentication. On the other hand, when it is determined that the authentication has not succeeded, that is, the authentication has failed, the communication unit 44 of the input support server 11 notifies the client 12 of failure in authentication.

In such an authentication process, a process in which the word dictionary database 22 corresponding to the client 12 is specified according to necessity is included. “According to necessity” depends on whether the word dictionary database 22 is a database prepared for every user. Although there is a case in which the authentication process itself is performed to check the validity of access upon access to one's own blog and the like, or at other times, an authentication process for specifying the word dictionary database 22 may be omitted depending on whether the word dictionary database 22 is a database prepared for every user.

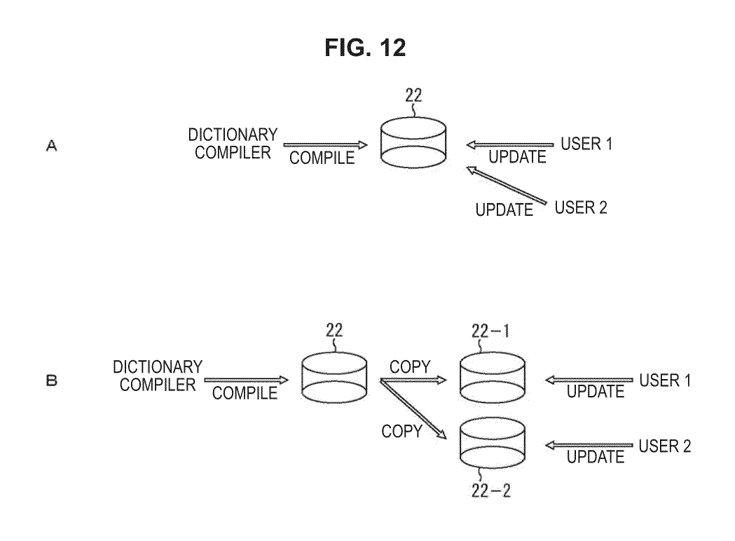

This will be described with reference to FIG. 12. First, the word dictionary database 22 is compiled by a dictionary compiler. A process of the dictionary compiler compiling the word dictionary database 22 and a data structure of the word dictionary database 22 itself will be described later.

The word dictionary database 22 compiled by a dictionary compiler is updated every time it is used by the user or at predetermined intervals, and becomes a database that can suggest more appropriate words to the user. This update process will also be described later. A state shown in FIG. 12A shows a case in which the word dictionary database 22 is shared among a plurality of users. When the word dictionary database 22 is shared among a plurality of users, the word dictionary database 22 is updated depending on process results according to different users indicated by user 1 and user 2.

When the word dictionary database 22 is shared among a plurality of users, since it is unnecessary to identify a user (client 12), an authentication process performed to specify the word dictionary database 22 is not necessary, and it is possible to omit such an authentication process.

This word dictionary database 22 is updated by the plurality of users, and thereby becomes a more general dictionary. Details of the word dictionary database 22 will be described later, but in the word dictionary database 22, a label word is connected with a plurality of words suitable for a case in which the label word is replaced with abstract words. It is possible to set this word dictionary database 22 as a database of words that are generally determined to be abstract with respect to a predetermined word.

On the other hand, in a state shown FIG. 12B, the word dictionary database 22 is compiled by a dictionary compiler, like in the state shown in FIG. 12A, but there is a difference in that the compiled word dictionary database 22 is copied (duplicated) to generate a word dictionary database 22-1 and a word dictionary database 22-2.

The word dictionary database 22-1 is a database for user 1, and the word dictionary database 22-2 is a database for user 2. The word dictionary database 22-1 is updated depending on process results of user 1, and the word dictionary database 22-2 is updated depending on process results of user 2.

In this way, when the word dictionary database 22 is prepared for individual users, it is necessary to identify an accessing user (client 12), and thus an authentication process is performed.

This word dictionary database 22 is updated by individual users and thereby becomes a dictionary suitable for the individual users. It is possible to set this word dictionary database 22 as a database of words corresponding to the individual users' preferences, situations they face, or the like.

Like this, whether to perform an authentication process may be set according to whether the word dictionary database 22 is shared. Needless to say, when the word dictionary database 22 is used, the word dictionary database 22 can also be set to perform an authentication process regardless of whether the word dictionary database 22 is for common use. Here, an example in which an authentication process is performed has been described.

Description will return to the flowcharts shown in FIG. 10 and FIG. 11. When the client authentication process of the input support server 11 is finished, and the result is transmitted to the side of the client 12, the acquisition unit 81 acquires the authentication result in step S3 (FIG. 10).

In step S4, the determination unit 83 of the client 12 determines whether the authentication has succeeded. When it is determined in step S4 that the authentication has not succeeded, that is, when failure in authentication is reported by the input support server 11, the process returns to step S1, and the subsequent process is repeated.

When it is determined in step S4 that the authentication has succeeded, that is, when success in authentication is reported by the input support server 11, the process proceeds to step S5. In step S5, the acquisition unit 81 of the client 12 acquires content input by the user. In step S6, the communication unit 82 of the client 12 transmits the content to the input support server 11 through the transceiver 64 and the Internet 14.

Timings of acquiring and transmitting the content are as described with reference to FIG. 5 to FIG. 9, and for example, when a word is input while the user is inputting a sentence, the word (a predetermined number of characters constituting the word) is acquired and transmitted. Here, although description will continue on the assumption that content is acquired and transmitted, the content is a sentence, and the assumption means that some characters constituting a word in the middle of the sentence (in an unfinished state) are acquired and transmitted.

In step 32 of FIG. 11, the acquisition 41 of the input support server 11 acquires the content transmitted from the client 12 through the Internet 14 and the transceiver 23. In other words, the content, transmitted in the process of step S6 of FIG. 10 is acquired.

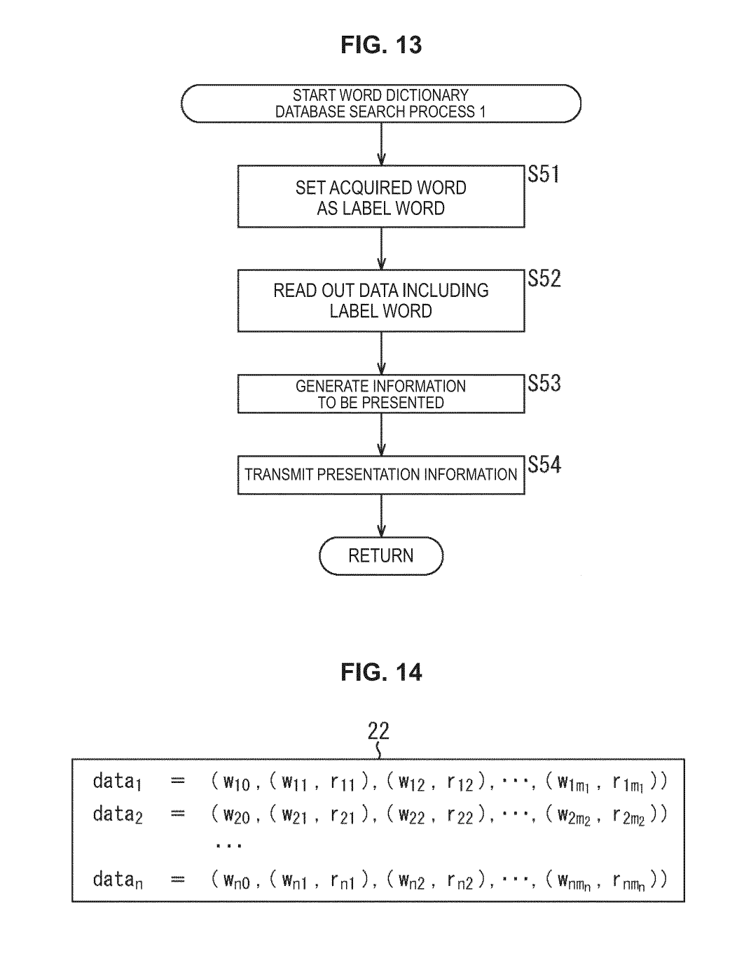

In step 33 of FIG. 11, the input support server 11 performs a word dictionary database search process. The word dictionary database search process will be described with reference to FIG. 13

[Regarding Word Dictionary Database Search Process 1]

FIG. 13 is a flowchart illustrating word dictionary database search process 1. A word dictionary database search process is performed differently according to the number of acquired words, or the like. Here, description will be added regarding word dictionary database search process 1 first.

In an example of FIG. 13, description will be made regarding a case of searching the word dictionary database 22 for a word that coincides with a word included in a sentence as content.

In step S51, the search unit 43 sets an acquired word as a label word. In step S52, data including the label word is read out from the word dictionary database 22. Here, in order to describe a label word and data, a data structure of the word dictionary database 22 will be described.

The word dictionary database 22 has a plurality of pieces of data. One piece of data is mentioned as dataᵢ. dataᵢ is data in which a label word is connected with a plurality of words. dataᵢ=((label word i, (word 1, word 2, . . . , and word m))

In addition, weights are also connected with a respective plurality of words that have been connected with a label word. Here, when the word is indicated by w, and the weight is indicated by r, data; is indicated as follows. Also, since an initial value of the weight is 1, data is indicated as follows when the weight is substituted by 1.

dataᵢ=(wᵢ₀,(wᵢ₁,rᵢ₁),(wᵢ₂,rᵢ₂), and(wᵢₘ,rᵢₘ))=(label word i,(word 1,1),(word 2,1), . . . ,and(word m,1))

A plurality of pieces of such data is stored in the word dictionary database 22. For example, data is stored as shown in FIG. 14. In the example shown in FIG. 14, n pieces of data dataₙ to data are stored. In FIG. 14, for example, data₁ has a data configuration as follows.

dataᵢ=(w₁₀,(wᵢ₁,r₁₁),(wᵢ₂,r₁₂, . . . ,and(w₁ₘ,r₁ₘ))

w₁₀ is a label word of dataᵢ. In the subscript “10”, the first digit “1” denotes that the corresponding word is data of data₁, and the second digit “0” denotes that the corresponding word is a label word.

w₁₁, w₁₂, . . . , and w₁ₘ are words that each are connected with the label word w₁₀ of data₁. In the subscripts, the first digits denote that the corresponding words are data of data₁, and the second digits indicate rankings of the corresponding words when the corresponding words are lined up in order of abstraction level.

An abstraction level is a value calculated according to an arithmetic operation to be described later, and is a degree at which it is not possible to uniquely specify a label word, a meaning of the corresponding word does not deviate far from the label word, and the meaning of a sentence does not become odd even if the label word is replaced with the corresponding word.

r₁₁ is a weight of the word w₁₁, r₁₂ is a weight of the word w₁₂, . . . , and r₁ₘ is a weight of the word w₁ₘ. Subscripts are the same as those of connected words, respectively.

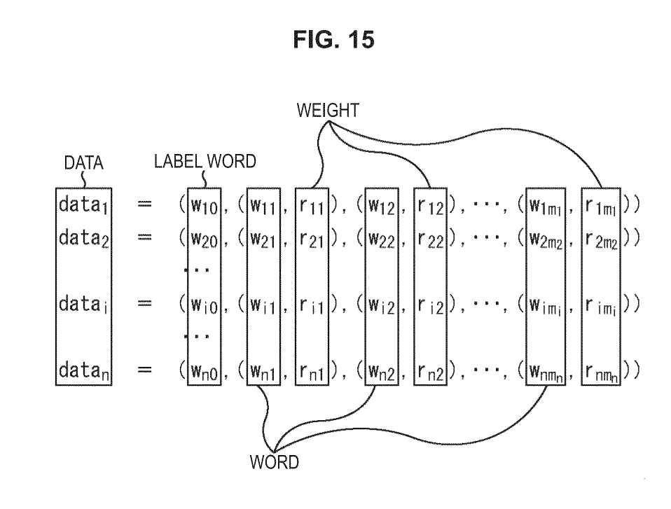

The other pieces of data data₂ to dataₙ also have the same configuration. FIG. 15 separately illustrates pieces of data, label words, words, and weights shown in FIG. 14. The pieces of data are data₁, data₂, . . . , dataᵢ, . . . , and dataₙ.

The label words are w₁₀, w₂₀, . . . , wᵢ₀, . . . , and wₙ₀. The words are

w₁₁, w₂₁, . . . , wᵢ₁, . . . , and wₙ₁,

w₁₂, w₂₂, . . . , wᵢ₂, . . . , , and wₙ₂,

w₁ₘ₁, w₂ₘ₂, . . . , wᵢₘᵢ, . . . , and wₙₘₙ.

The weights are

r₁₁, r₂₁, . . . , rᵢ₁, . . . , and rₙ₁,

r₁₂, r₂₂, . . . , rᵢ₂, . . . , and rₙ₂,

r₁ₘ₁, r₂ₘ₂, . . . , rᵢₘᵢ, . . . , and rₙₘₙ.

The word dictionary database 22 is a database storing a plurality of pieces of data in which label words, words, and weights are connected with each other as described above. The word dictionary database search process (FIG. 13) is performed by searching this word dictionary database 22.

Description will return to the flowchart of FIG. 13. In step S51, the acquired word is set as the label word, and in step S52, the data including the set label word is read out by searching the word dictionary database 22.

When the acquired word is word A, word A is set as the label word. Data having word A as a label word is read out from the word dictionary database 22. When the label word w₁₀ is word A, and the word dictionary database 22 shown in FIG. 14 is searched, data₁ is read out.

In step S52, the data including the label word may not be in the word dictionary database 22, and no data may be read out. In this case, the subsequent process is not performed, and the process enters a standby state until the next word is acquired.

Label words of the word dictionary database 22 are set to be words related to privacy. When the word that has been acquired through the process of step S51 and set as the label word is a word related to privacy, the word is present in the word dictionary database 22 as a label word. Thus, in this case, data is read out from the word dictionary database 22 in step S52.

On the other hand, when the word that has been acquired through the process of step S51 and set as the label word is a word related to privacy, the word is not present in the word dictionary database 22 as a label word. Thus, in this case, no data is read out from the word dictionary database 22 in step S52.

As described above, by limiting label words stored in the word dictionary database 22 to words related to privacy, it becomes possible to perform the process only when a word related to privacy becomes a label word. In other words, according to label words stored in the word dictionary database 22, it becomes possible to implement the function of a filter.

Although not included as a process in the flowchart of FIG. 13, a step of making a determination of “whether the set label word has been registered in the word dictionary database 22” may be interposed between step S51 and step S52. If the step of making such a determination has been prepared, it is possible to configure the process of step S52 to be performed when it is determined that “the set label word has been registered in the word dictionary database 22”, and the process to be finished at a point in time when it is determined that the set label word has not been registered in the word dictionary database 22.

When the label word is present in the word dictionary database 22, and data is read out, information to be presented is generated in step S53. The information to be presented (hereinafter referred to as presentation information) is, for example, information displayed in the speech balloon 101 (FIG. 4A) described with reference to FIG. 4. As described with reference to FIG. 4A, candidates for a replacement word are displayed between the item “No change” and the item “New input”. These candidates for a replacement word are words in data.

In other words, in this example, the candidates for a replacement word are words in data referred to as data₁. Since data₁ is

data₁=(w₁₀, (w₁₁, r₁₁), (w₁₂, r₁₂), . . . , and (w₁ₘ, r₁ₘ)),

words are w₁₁, w₁₂, . . . , and w₁ₘ. These w₁₁, w₁₂, . . . , and w₁ₘ, are indicated as a word string. Information in which the word string becomes a line interposed between the item “No change” and the item “New input” is presentation information. In other words, in this case, information of a line

No change, w₁₁, wᵢ₂, . . . , wᵢₘ, and New input

becomes the presentation information.

In step S54, the communication unit 44 of the input support server 11 transmits the presentation information to the client 12 through the transceiver 23 and the Internet 14.

[Regarding Word Dictionary Database Search Process 2]

Word dictionary database search process 1 has been described with reference to FIG. 13 as a process for a case in which one word is transmitted. Transmission may not be performed for every word, but rather, for example, at a point in time when one sentence is input, morphological analysis and the like may be performed on the sentence to extract a noun, and the noun may be transmitted. In this case, there is a probability that a plurality of words will be transmitted.

In addition, when a plurality of words are presented to the user by the predictive conversion function as described with reference to FIG. 8, there is also a probability that the presented plurality of words will be transmitted.

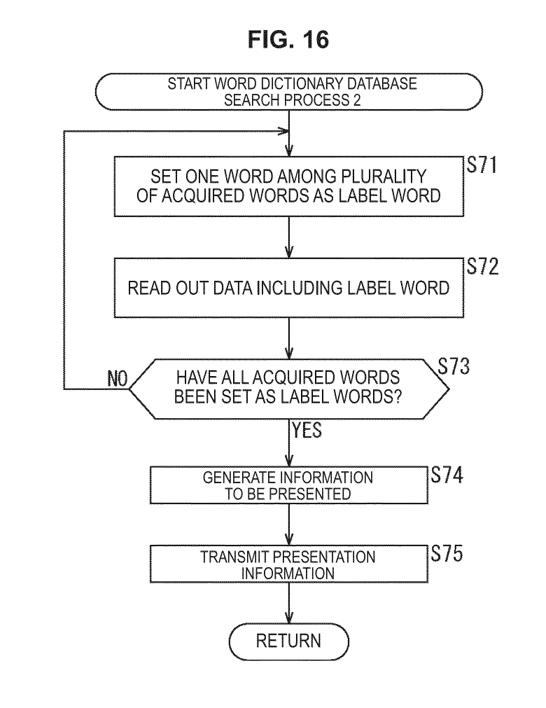

Word dictionary database search process 2 that is performed based on a flowchart illustrated in FIG. 16 is a process for a case in which a plurality of words are transmitted. First, in step S71, a plurality of words are acquired, and one word among the plurality of acquired words is set as a label word. On the label word, a process of step S72 is performed. In step S72, data including the label word is read out from the word dictionary database 22.

In step S73, it is determined whether all the acquired words have been set as label words. When it is determined in step S73 that all the acquired words have not been set as label words, the process returns to step S71, and another word is set as a label word, so that the process of step S72 and the subsequent step is repeated on the label word that has been set as a new label word.

On the other hand, when it is determined in step S73 that all the acquired words have been set as label words, the process proceeds to step S74. In step S74, presentation information is generated. In this case, presentation information is generated for each of the plurality of words. Then, in step S75, the presentation information is transmitted to the client 12.

[Regarding Word Dictionary Database Search Process 3]

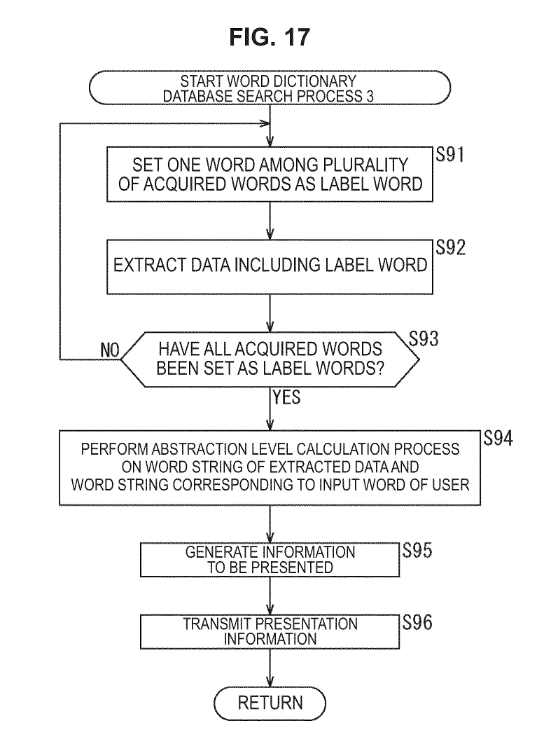

Next, word dictionary database search process 3 will be described with reference to FIG. 17. Like word dictionary database search process 2, word dictionary database search process 3 is also a process for a case in which a plurality of words are acquired. Word dictionary database search process 3 illustrated in FIG. 17 and word dictionary database search process 2 illustrated in FIG. 16 are the same except that a process of step S94 is added.

In other words, in a process of steps S91 to S92, data including each of a plurality of acquired words is read out, like in the process of steps S71 to S73. In step S94, an abstraction level calculation process is performed on a word string of extracted data and a word string corresponding to an input word of the user. This abstraction level calculation process is also performed upon an update of the word dictionary database 22 and other times, and thus will be described in description of an update process.

By calculating abstraction levels, rankings in abstraction level are determined among words of a word string that have been targets. By rearranging the words in order of high abstraction level, presentation information is generated (step S95). Then, in step S96, the generated presentation information is transmitted to the client 12.

[Regarding Word Dictionary Database Search Process 4]

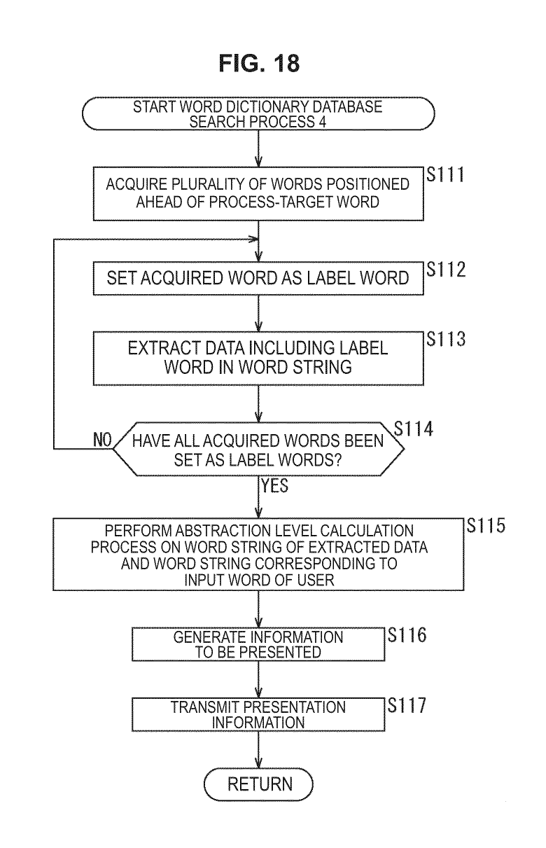

Next, word dictionary database search process 4 will be described reference to FIG. 18. Like word dictionary database search process 2 or word dictionary database search process 3, word dictionary database search process 4 is also a process for a case in which a plurality of words are acquired, but the acquired words are different from those of word dictionary database search process 2 or word dictionary database search process 3.

In word dictionary database search process 4, a plurality of words that have been process targets and a plurality of words that have been input at points in time before the words are acquired. First, in step S111, a plurality of words positioned ahead of a process-target word are acquired. The number of the plurality of acquired words may be any number. Although the plurality of words positioned ahead of the process-target word are acquired, it is preferable for a word immediately ahead of the process-target word to be included in the plurality of acquired words.

In step S112, one word among the plurality of acquired words is set as a label word. On the label word, a process of step S113 is performed. In step S113, data including the label word is read out from the word dictionary database 22.

In step S114, it is determined whether all the acquired words have been set as label words. When it is determined in step S114 that all the acquired words have not been set as label words, the process returns to step S112, and another word is set as a label word, so that the process of step S113 and the subsequent step is repeated on the label word that has been set as a new label word,

On the other hand, when it is determined in step S114 that all the acquired words have been set as label words, the process proceeds to step S115. In step S115, an abstraction level calculation process is performed on a word string of extracted data and a word string corresponding to an input word of the user. This abstraction level calculation process will be described later.

By calculating abstraction levels, rankings in abstraction level are determined among words of a word string that have been targets. By rearranging the words in order of high abstraction level, presentation information is generated (step S116). Then, in step S117, the generated presentation information is transmitted to the client 12.

As described above, a process related to a search in the word dictionary database 22 can also be varied depending on the number of acquired words or the like. These processes may be selectively performed, any one process may be performed at all times, or the processes may be combined and performed.

Description will return to the flowchart shown in FIG. 10. In step S7 of FIG. 10, the acquisition unit 81 of the client 12 acquires presentation information transmitted from the input support server 11. In other words, presentation information that has been transmitted in the process of step S54 of FIG. 13 is acquired.

In step S8, the output unit 84 of the client 12 outputs the presentation information to the output device 63. In other words, the presentation information is presented to the user. For example, the presentation information is displayed in the speech balloon 101 as shown in FIG. 5B and thereby presented to the user.

With reference to FIG. 5 again, description will be made regarding a process of steps S5 to S8 performed on the side of the client 12 and step S32 and step S33 (the process of the flowchart illustrated in FIG. 13) performed on the side of the input support server 11.

Sentence A shown in FIG. 5A is in a state in which an input has been made up to “Thinking of buying a recently released game, yesterday, I went to sony” on the side of the client 12. When such sentence A is input, and the word “sony” is selected by the user, the word “sony” is transmitted to the input support server 11 in response to the selection. In other words, in this case, the word “sony” is acquired as content by using selection of the word “sony” as a trigger in step S5 (FIG. 10), and transmitted to the input support server 11 in the process of step S6.

As a result of performing such a transmission, the word “sony” is acquired by the input support server 11 in step S32. Then, the word “sony” is set as a label word (the process of step S51 of FIG. 13), and data that has the word “sony” as a label word is read out from the word dictionary database 22 (the process of step S52 of FIG. 13),

In a case as described with reference to FIG. 5, the word string

“A manufacturer”, “a certain manufacturer”, “an electrical equipment manufacturer”, “a company”, “a workplace”, “an place of employment”, “a certain enterprise”, “an investment outlet” and “a Japanese company” are read out from the word dictionary database 22.

When such a word string is read out, presentation information including the word string is generated in the process of step S53 of FIG. 13. In other words, in this case, presentation information

“No change”, “a manufacturer”, “a certain manufacturer”, “an electrical equipment manufacturer”, “a company”, “a workplace”, “a place of employment”, “a certain enterprise”, “an investment outlet”, “a Japanese company” and “New input” are generated.

The generated presentation information is transmitted from the input support server 11 to the client 12 in step S54 of FIG. 13. As a result, in the client 12, the presentation information from the input support server 11 is acquired through the process of step S7 of FIG. 10, and output to an output device such as a display or the like through the process of step S8.

The output presentation information is presented to the user using a screen as shown in FIG. 5B. In other words, the speech balloon 101 pops up from the word “sony”, and the presentation information is displayed in the speech balloon 101. As described above, by using personal selection of a user as a trigger, a replacement-target word (content) is transmitted, and the results are received, so that words for replacement are presented to the user.

Such a process is performed in the same way as a process related to the timings of displaying a speech balloon described with reference to FIG. 6 to FIG. 9, and thus detailed description thereof will be omitted here. In other words, the process has the same flow as in the description made with reference to FIG. 6 to FIG. 9 in which, when a trigger is pulled, for example, when a trigger of performing a conversion or the like occurs, a word is transmitted from the client 12 to the input support server 11, and presentation information is received from the input support server 11 as a response to the word.

Description will return to the flowcharts illustrated in FIG. 10 and FIG. 11, and in step S8 of FIG. 10, the presentation information is presented to the user by the client 12. For example, the speech balloon 101 as shown n FIG. 5B is displayed, and thereby presentation of the presentation information is made.

The user selects any one among the item “No change”, one word in the word string, and the item “New input” displayed in the speech balloon 101. In step S9, a process for reflecting such a selection result is performed.

In other words, as described with reference to FIG. 4, when the item “No change” is selected, the input sentence becomes a sentence in which a word (“sony” in the example of FIG. 4) that has been a replacement target remains unchanged as shown in FIG. 4B. Also, when no selection has been made, the process proceeds assuming that the item “No change” has been selected.

When one word in the word string has been selected, the input sentence is altered into a sentence in which the word that has been a replacement target is replaced with the selected word as shown in FIG. 4C. Also, when the item “New input” is selected, the speech balloon 111 providing a section to which the user can input a desired word is displayed, and the input sentence is altered into a sentence in which the word having been a replacement target is replaced with a word having been input to the section as shown in FIG. 4D.

When such a process is performed in step S9, the process result (selection result) is transmitted from the client 12 to the input support server 11 in step S10. The selection information includes information about which one has been selected from among “No change”, a word in the word string, and “New input”. When a word in the word string has been selected, the selected word (or an identifier by which it is possible to uniquely identify the word) is included as well. Also, when “New input” has been selected, a word that has been input by the user is included as well.

Such a process is performed as a process related to input support in the client 12.

In the meantime, in the input support server 11, the selection information about what kind of selection has been made as a result of presenting the presentation information on the side of the client 12 is acquired in step S34 (FIG. 11). When the selection information is acquired, an update process is started by the update unit 47 (FIG. 2) in step S35.

[Regarding Update Process]

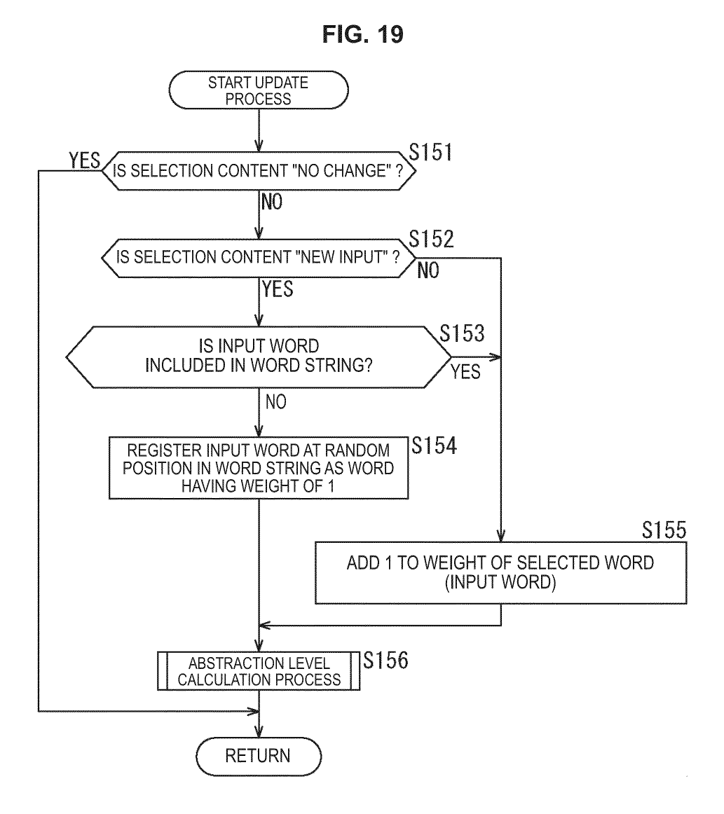

With reference to FIG. 19, description will be made regarding an update process performed in step S35. The update process is a process of updating data in the word dictionary database 22 using selection information.

Here, although it has been described that the update process is performed when selection information from the side of the client 12 is received, an update process may not be performed every time selection information is received, but rather an update process of collecting and reflecting erstwhile selection information may be performed when selection information is received a predetermined number of times.

When the word dictionary database 22 is a database shared by a plurality of users, the word dictionary database 22 is considered as an update target. When the word dictionary database 22 is a database for individual users, the word dictionary database 22 that has been assigned to the user of the client 12 having sent selection information is considered as an update target.

In step S151 it is determined whether selection content shown by selection information indicates that the item “No change” has been selected. When it is determined in step S151 that the selection content indicates that the item “No change” has been selected, the update process is finished.

On the other hand, when it is determined in step S151 that the selection content does not indicate that the item “No change” has been selected, the process proceeds to step S151 in step S152, it is determined whether the selection content indicates that the item “New input” has been selected. When it is determined in step S152 that the selection content indicates that the item “New input” has been selected, the process proceeds to step S153.

In step S153, it is determined whether a word having been input by the user as a new input is not included in a word string provided to the user side as presentation information. For example, a case is assumed in which the user overlooks a word having been displayed in the speech balloon 101 (FIG. 4 and the like), selects the item “New input”, and inputs the word.

Also, there is a probability that there will be a word which has been unable to be displayed in the speech balloon 101 and thus has not been presented to the user in the word string, and as a result, there will be a word having not been presented to the user. As a result, a case is assumed in which the user has selected the item “New input”, and input the word. In view of such a situation, in step S153, it is determined whether a word having been input by the user as a new input is not included in a word string provided to the user side as presentation information.

When it is determined in step S153 that the word having been input by the user as a new input is not included in the word string provided to the user side as presentation information, the process proceeds to step S154. In this case, the word having been input by the user is a word that has not been presented to the user side as the word string. Thus, the word having been input by the user is additionally registered in the word dictionary database 22 as one word string in step S154.

The word that has been newly input by the user to correspond to a label word having become a base on which presentation information is presented is registered as the word string. As described with reference to FIG. 15 and the like, data is considered as data in which a plurality of words is connected with the one label word. The connected words are lined up in order of abstraction level and managed.

An abstraction level of the word that is newly added to the word string has not yet been calculated at this point in time, and thus it is not possible to determine which position in the word string the word will be placed at. Thus, description will continue on the assumption that the new word is added at a random position of the word string. It is also possible to add the new word at a predetermined position referred to as middle or last, rather than at a random position.

Regardless of the position at which the new word is added, as will be described later, abstraction levels are calculated again, and a process of updating a line of the word string is performed, so that the line can be altered into an appropriate line. Thus, an addition position in step S154 may be any position, and description will continue on the assumption that the new word is added at a random position.

Weights are connected with respective words of the word string that has been connected with the one label word. A weight of the newly added word is additionally registered as “1”. As described above, a word that has been newly input by the user is added as one word in a word string.

On the other hand, when it is determined in step S153 that the word having been input by the user as a new input is included in the word string provided to the user side as presentation information, the process proceeds to step S155. In this case, as described above, it is possible to imagine a situation in which a word has been presented to the user, but the user overlooks the word and makes a new input, or other situations.

In such a case, in step S155, an update of the word dictionary database 22 is performed by adding 1 to the weights of the words of the word string corresponding to the input word.

In the meantime, even when it is determined in step S152 that the selection content does not indicate that the item “New input” has been selected, the process proceeds to step S155. In this case, since the selection content is neither “No change” nor “New input”, a word in the word string included in the presentation information has been selected.

In such a case, an update of the word dictionary database 22 is performed by updating a weight of the selected word with a value increased by 1.

When a new word is added to the word string in step S154, or a new word is added to the word string in step S155, the process proceeds to step S156. In step S156, an abstraction level calculation process is performed.

In other words, when there is an alteration of data in the word dictionary database 22, an abstraction level calculation process is performed. Such an abstraction level calculation process performed upon an update of the word dictionary database 22 will be properly mentioned as an update-time abstraction level calculation process.

The update-time abstraction level calculation process may be a process that should be performed when a new word is added to a word string, or may be performed at a point in time when such a situation occurs a predetermined number of times. For example, it is also possible to configure the update-time abstraction level calculation process to be performed at a point in time when the number of times that “New input” has been selected exceeds a threshold value that has been set in advance.

An abstraction level calculation process is not only performed upon an update but also when words of a plurality of word strings are lined up in order of abstraction level in word dictionary database search process 3 or word dictionary database search process 4 described above, and in other cases. Such an abstraction level calculation process performed in a word dictionary database search process will be properly mentioned as a search-time abstraction level calculation process.

In addition, an abstraction level calculation process is also performed at a point in time when the word dictionary database 22 is compiled, in other words, at a point in time before a process related to input support as described above is started. Such an abstraction level calculation process performed before start of input support will be properly mentioned as a prior abstraction level calculation process.

In this embodiment, even without performing a prior abstraction level calculation process, an update-time abstraction level calculation process is performed to update the word dictionary database 22 every time input support for the user is performed, and thus the word dictionary database 22 can be made into an appropriate database with the passage of time.

[Regarding Abstraction Level Calculation Process]

A prior abstraction level calculation process, an update-time abstraction level calculation process, and a search-time abstraction level calculation process are performed in the same way except that pieces of data considered as process targets are different. In other words, while all pieces of data in the word dictionary database 22 are considered as targets in a prior abstraction level calculation process, only a piece of data considered as a process target is considered as a target in an update-time abstraction level calculation process and a search-time abstraction level calculation process. As described above, since only ranges considered as process targets are different and basic processes are the same, description will be further made below regarding a prior abstraction level calculation process, an update-time abstraction level calculation process, and a search-time abstraction level calculation process as an abstraction level calculation process altogether.

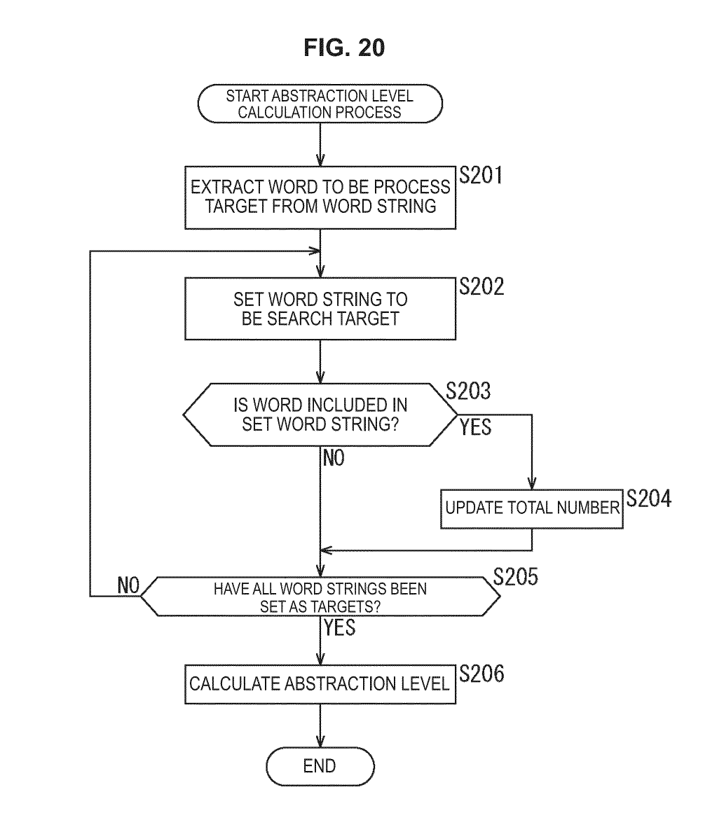

FIG. 20 is a flowchart illustrating an abstraction level calculation process. An abstraction level is calculated by the calculation unit 48 of the input support server 11. In step S201, a word that will be a process target is extracted from a word string.

data₁=(w₁₀, (wᵢ₁, r₁₁), (wᵢ₂, w₁₂), . . . , and (w₁ₘ, r₁ₘ))

For example, data₁ is such data, but a word, for example, a word w₁₁, that is set as a process target is extracted from a word string (w₁₁, w₁₂, . . . , and W₁ₘ) in the data.

In step S202, a word string that will be a search target is set. For example, a word string of data₁ mentioned above is set as a search target. In step S203, it is determined whether the word set as the process target is present in the word string set as the search target.

For example, when the word considered as the process target is the word w₁₁, and the word string considered as the search target is the word string (w₁₁, w₁₂, . . . , and w₁ₘ) of data₁, it is determined in step S203 that the word set as the process target is present in the word string set as the search target. When it is determined that the word is present in the word string as mentioned above, the process proceeds to step S204, and a total number is updated.

The total number is a numerical value that indicates how many word strings including the word considered as the process target are present among word strings registered in the word dictionary database 22.

When the total number is updated in step S204, or it is determined in step S203 that the word set as the process target is not included in the set word string, the process proceeds to step S205. In step S205, it is determined whether all word strings have been set as search targets.

When it is determined in step S205 that all word strings have not been set as search targets, the process returns to step S202, and the subsequent process is repeated. For example, a word string of data₂, a word string of data₃, and the like are considered as search targets in sequence, and it is determined whether the word considered as the process target is included.

By repeating such a process, the number of times that the word considered as the process target is included among words in word strings registered with the word dictionary database 22, that is, the total number, is obtained as described above. Such a process is a process of classifying data including a predetermined word and data not including the predetermined word, and considered as a second classification process related to the label word.

When the total number of the word considered as the one process target is calculated in this way, it is determined in step S205 that all word strings have been set as search targets, and the process proceeds to step S206. In step S206, the obtained total number and the like are substituted into a predetermined operation expression, so that an abstraction level is calculated.

For example, an abstraction level is obtained from equation (1)

$${I}_{ij} = \frac{{n}_{ij} + {r}_{ij} - 1}{n + {r}_{ij} - 1} \qquad ( 1 )$$

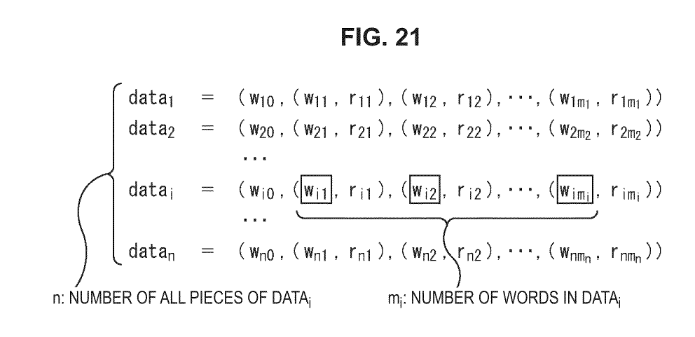

In equation (1), Iᵢⱼ indicates an abstraction level. As shown in FIG. 21, n in equation (1) indicates the number of all pieces of data, nᵢⱼ is the number of pieces of data including a word wᵢⱼ in a word string, and corresponds to a total number. rᵢⱼ is a weight of the word wᵢⱼ.

Abstraction levels are calculated from such equation (1). Such a process is performed on all words in a word string, and thereby abstraction levels of all the words in the word string are calculated. After that, the words are lined up in descending order of abstraction level, and the line is considered as a line of the word string in data.

When an abstraction level is calculated based on equation (1), the closer to 1 the calculated value is, the higher the abstraction level is. Thus, reordering is performed so that the closer to 1 a word is, the higher it ranks in alignment order. A weight reflects a frequency of use of the user.

Thus, a large weight of a word indicates that the word is frequently used by the user, and the more frequently used like this by the user a word is, the closer to 1 a value of an abstraction level calculated in equation (1) is set to become.

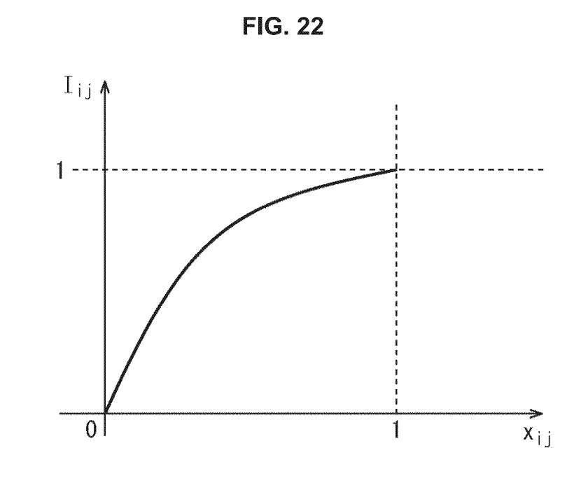

Here, description will continue on the assumption that an abstraction level is calculated according to equation (1), but any function is favorable as long as it has equation (2) below as a variable to be a monotonically increasing function as shown in FIG. 22.

$${x}_{ij} = \frac{{n}_{ij} + {r}_{ij} - 1}{n + {r}_{ij} - 1} \qquad ( 2 )$$

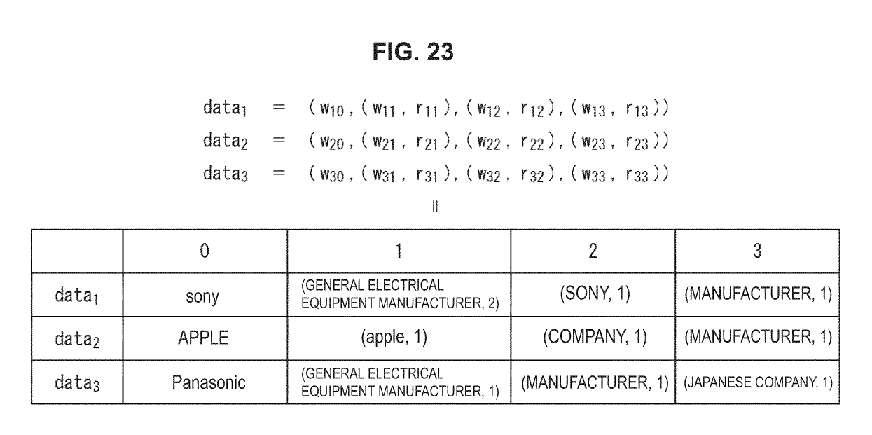

By giving a detailed example of the word dictionary database 22, an abstraction level calculation process will be described. FIG. 23 is a detailed example of the word dictionary database 22. The word dictionary database 22, shown in FIG. 23 includes 3 pieces of data data₁, data₂, and data₃. Thus, in this case, the number of all pieces of data becomes “3”, and n=3.

A label word w₁₀ of data₁ is “sony”. In a word string of data₁, a word w₁₁ is “general electrical equipment manufacturer,” and a weight r₁₁ connected with the word w₁₁ is “2”. Likewise, in the word string of dataᵢ, a word wᵢ₂ is “SONY” (registered trademark), and a weight r₁₂ connected with the word w₁₂ is “1”. Likewise, in the word string of data₁, a word w₁₃ is “manufacturer,” and a weight r₁₃ connected with the word w₁₃ is “1”.

Likewise, a label word w₂₀ of data₂ is “APPLE” (registered trademark). In a word string of data₂, a word w₂₁ is “apple”, and a weight r₂₁ connected with the word w₂₁ is “1”. Likewise, in the word string of data₂, a word w₂₂ is “company”, and a weight r₂₂ connected with the word w₂₂ is “1”. Likewise, in the word string of data₂, a word w₂₃ is “manufacturer,” and a weight r₂₃ connected with the word w₂₃ is “1”.

A label word w₃₀ of data₃ is “Panasonic” (registered trademark). In a word string of data₃, a word w₃₁ is “general electrical equipment manufacturer”, and a weight r₃₁ connected with the word w₃₁ is “1”. Likewise, in the word string of data₃, a word w₃₂ is “manufacturer”, and a weight r₃₂ connected with the word w₃₂ is “1”. Likewise, in the word string of data₃, a word w₃₃ is “manufacturer”, and a weight r₃₃ connected with the word wzz is “1”.

It is assumed that an abstraction level calculation process is performed on this word dictionary database 22. In step S201, a word considered as a process target is extracted from a word string. Here, this extracted word is assumed to be the word w₁₁. The word w₁₁ is “general electrical equipment manufacturer”.

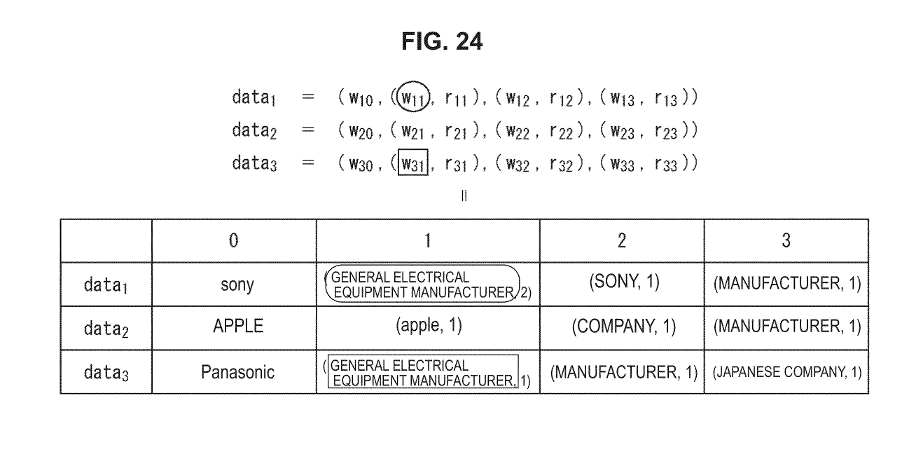

In FIG. 24, this extracted word w₁₁ is shown to be surrounded by a circle, and “general electrical equipment manufacturer” corresponding to the word w₁₁ is shown to be surrounded by a circle. In step S202, a word string to be a search target is set, and here, it is assumed that a word string of data₁ is set first. Since the word “general electrical equipment manufacturer” is included in data₁, a determination of YES is made in step S203, and a total number is updated in step S204. In this case, the total number becomes 1.

Since word strings of data₂ and data₃ have not been set as search targets, a determination of NO is made in step S205, and the process returns to step S202. In step S202, a word string of data, is set as a search-target word string. Since the word w₁₁ “general electrical equipment manufacturer” is not included in the word string of data₂, a determination of NO is made in step S203, and the process proceeds to step S205. In this case, the total number is not updated, and thus remains 1.

Since a word string of data₃ has not been set as a search target, a determination of NO is made in step S205, and the process returns to step S202. In step S202, the word string of data₃ is set as a search-target word string.

Since the words “general electrical equipment manufacturer” that are the same as the word w₁₁ “general electrical equipment manufacturer” are included in the data₂, a determination of YES is made in step S203. In FIG. 24, both the word w₃₁ and the words “general electrical equipment manufacturer” corresponding to the word w₃₁ are surrounded by quadrangles. In step S204, the total number is updated. In this case, the total number is updated to 2.

Since it is determined in step S205 that all the word strings have been search targets, the process proceeds to step S206, and an abstraction level is calculated based on equation (1). In this case, the abstraction level Iᵢⱼ in equation (1) is an abstraction level I₁₁. nᵢⱼ becomes n₁₁, and since the total number is 2, n₁₁=2.

Since the weight r₁₁ of the word with w₁₁ is “2”, d string, rᵢⱼ in equation (1) becomes r₁₁, and r₁₁=2. Although n in equation (1) is the number of pieces of data, 3 pieces of data data₁ to data₃ are present in the example shown in FIG. 24, and thus n=3. When these values are substituted into equation (1), the following is obtained.

I₁₁=(2+2−1)/(3+2−1)=¾

The abstraction level I₁₁ of the word w₁₁ becomes ¾.

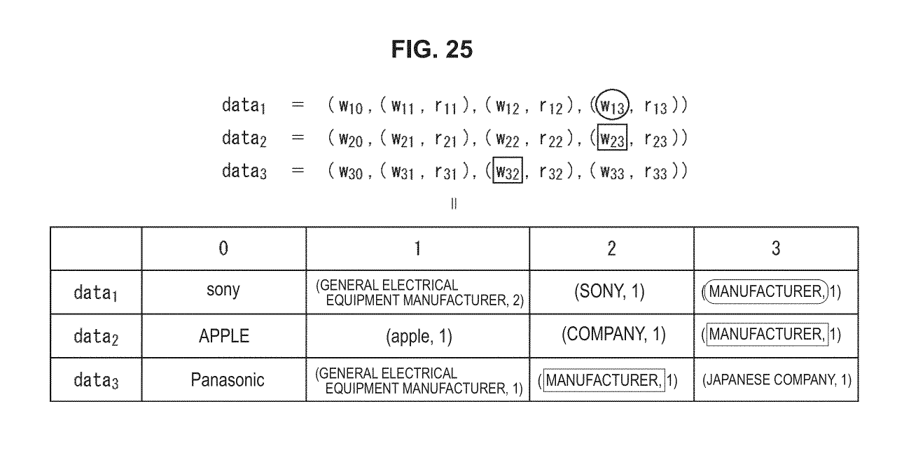

Another example is shown in FIG. 25. In the example shown in FIG. 25, the word “manufacturer” of the word w₁₃ is considered as a process-target word. This word w₁₃ considered as a process target and the word “manufacturer” corresponding to this word w₁₃ are shown to be surrounded by circles.

The word “manufacturer” has been registered as each of the word w₂₃ of data₂ and the word w₃₂ of data₃. Thus, in this case, the word “manufacturer” is registered in the word dictionary database 22 three times, and n₁₃=3.

An abstraction level I₃₂ of the word w₃₂ is calculated by substituting values as follows.

I₃₂(3+1−1)/(3+1−1)=1

Calculation results of a case in which an abstraction level is calculated for every word in all word strings in the word dictionary database in this way are listed below.

| | | |
|---|---|---|
| I₁₁ = ¾ | I₁₂ = ⅓ | I₁₃ = 1 |
| I₂₁ = ⅓ | I₂₂ = ⅓ | I₂₃ = 1 |
| I₃₁ = ⅔ | I₃₂ = 1 | I₃₃ = ⅓ |

Based on such abstraction levels, words in a word string in each piece of data are reordered. First, the words w₁₁, w₁₂, and w₁₃ in the word string of data₁ will be taken into consideration. The abstraction level I₁₁ of the word w₁₁ is “¾”, the abstraction level I₁₂ of the word w₁₂ is “⅓”, and the abstraction level I₁₃ of the word w₁₃ is “1”. When the abstraction levels are lined up in descending order, they fall in order of 1, ¾, and ⅓. When the words are lined up in the order of abstraction level, they fall in the order of

the word w₁₃, the word w₁₁, and the word w₁₂.

When hese are replaced with the words themselves, the order becomes

“manufacturer”, “general electrical equipment manufacturer”, and “SONY”.

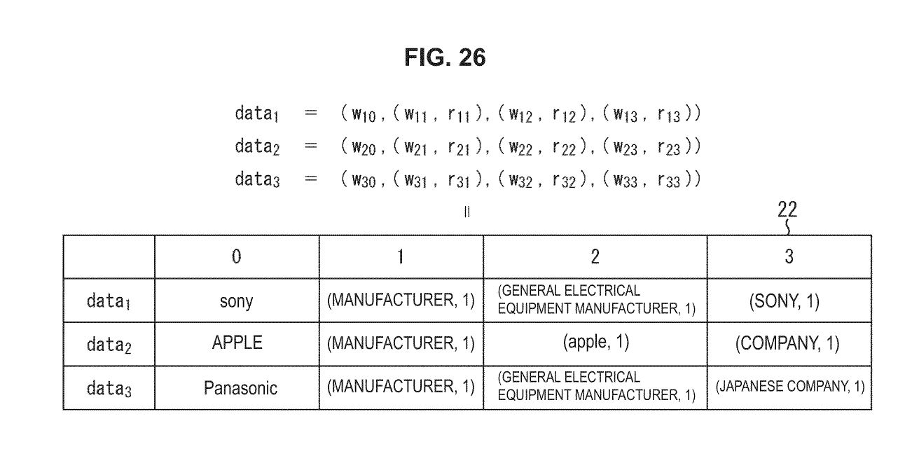

An example in which such reordering has been performed on data₂ and data₃ is shown in FIG. 26. As described above, data₁ is updated in order of “manufacturer”, “general electrical equipment manufacturer”, and “SONY” as a result of performing reordering based on the abstraction levels.

Likewise, data, is updated in order of “manufacturer”, “apple”, and “company”, and data₃ is updated in order of “manufacturer”, “general electrical equipment manufacturer”, and “Japanese company”. When abstraction levels are the same value, the abstraction levels may be randomly lined up no matter which word will rank high. As described above, words are lined up again in the order of abstraction level, so that data in the word dictionary database 22 is updated.

Here, since it is assumed that an abstraction level is calculated based on equation (1), description has been made assuming that a word having a high abstraction level has a value close to 1, and words are lined up in order of descending abstraction level. However, when an abstraction level is calculated based on another equation, these limitations are of no use.

For example, when an operation expression that causes a word having a higher abstraction level to rank high by lining up words in order of ascending abstraction level is used, words are lined up in order of high abstraction level by lining up the words in order of ascending abstraction level. A case of using another such arithmetic expression is also within the application range of the present technology.

[Regarding Compilation of Database 22]

While the word dictionary database 22 is updated as described above, it is possible to compile the word dictionary database that becomes a basis as will be described below.

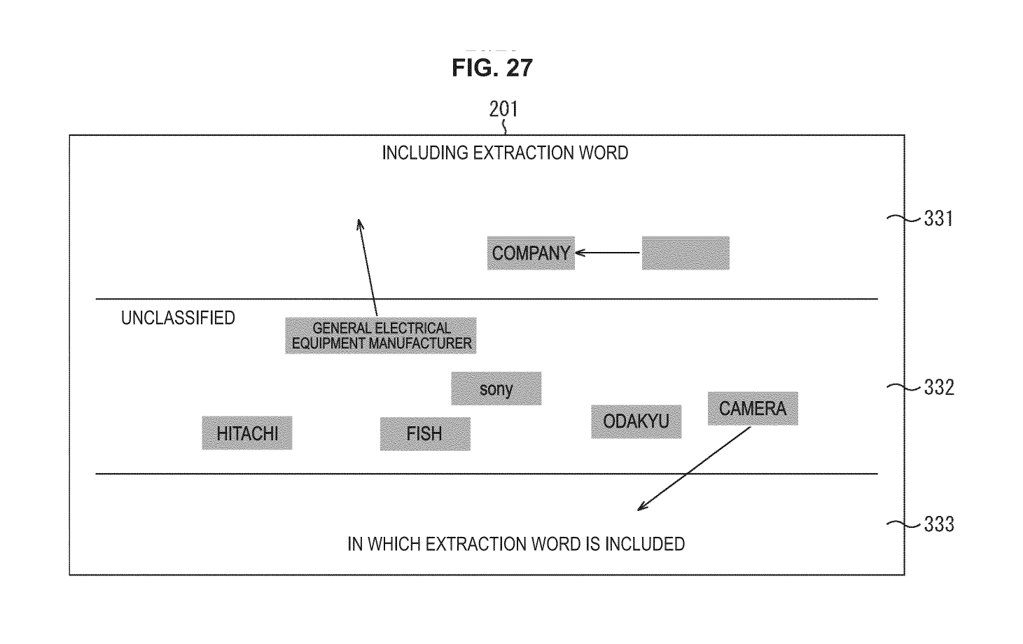

The word dictionary database 22 is compiled by a dictionary compiler. FIG. 27 is an example of a screen provided when a dictionary compiler compiles the word dictionary database 22. In a screen 201 shown in FIG. 27, three regions are provided. A region 331 arranged in an upper part of the screen 201 is considered as a region in which words “including an extraction word” are positioned.

A region 332 of a central part of the screen 201 is considered as a region in which unclassified words are positioned. A region 333 of a lower part of the screen 201 is considered as a region in which words “in which an extraction word is included” are positioned. The dictionary compiler selects a word to add to the word dictionary database 22 from among the unclassified words positioned in the region 332. For example, it is assumed that the word “sony” has been selected. The selected word is displayed to be distinguished from other words.

In this case, the word “sony” becomes an extraction word. Thus, words including this word “sony” are moved to the region 331, and words in which the word “sony” is included are moved to the region 333.

For example, when the dictionary compiler thinks that “general electrical equipment manufacturer” displayed in the non-classification region of the region 332 includes the word “sony,” the dictionary compiler moves the words “general electrical equipment manufacturer” from the region 332 to the region 331. In FIG. 27, arrows indicate movement.

In the region 331, the word “company” has already been displayed. In other words, in this case, the words “general electrical equipment manufacturer” are words that have been moved by the dictionary compiler to the region 331 as a result of being thought to include the word “company”.

When the word “sony” is processed as an extraction word in this way, if the words “general electrical equipment manufacturer” and “company” are positioned in the region 331 to which words including the extraction word are moved, the following data is created.

data=(sony,(general electrical equipment manufacturer,1),(company,1))

In other words, by using the word “sony” considered as an extraction word as a label word, data that has the words “general electrical equipment manufacturer” and “company” as a word string is created.

Also, when the dictionary compiler thinks that, for example, the word “sony” is included in “camera” displayed in the non-classification region of the region 332, the dictionary compiler moves the word “camera” from the region 332 to the region 333.

When the word “Sony” is processed as an extraction word in this way, if the word “camera” is positioned in the region 333 to which words in which the extraction word is included are moved, the following data is created.

data=(camera,(sony,1))

In other words, by using the word “camera” as a label word, data that has the word “sony” considered as the extraction word as a word string is created.

As described above, the dictionary compiler can make and add new data to the word dictionary database 22 by simply moving words in the region 332 in which unclassified words are displayed to the region 331 or the region 333. In other words, the dictionary compiler can make data in the word dictionary database 22 by simply answering a question about which word includes an extraction word and a question about which word the extraction word is included in.

Such an operation is repeated, and thereby the word dictionary database 22 is compiled.

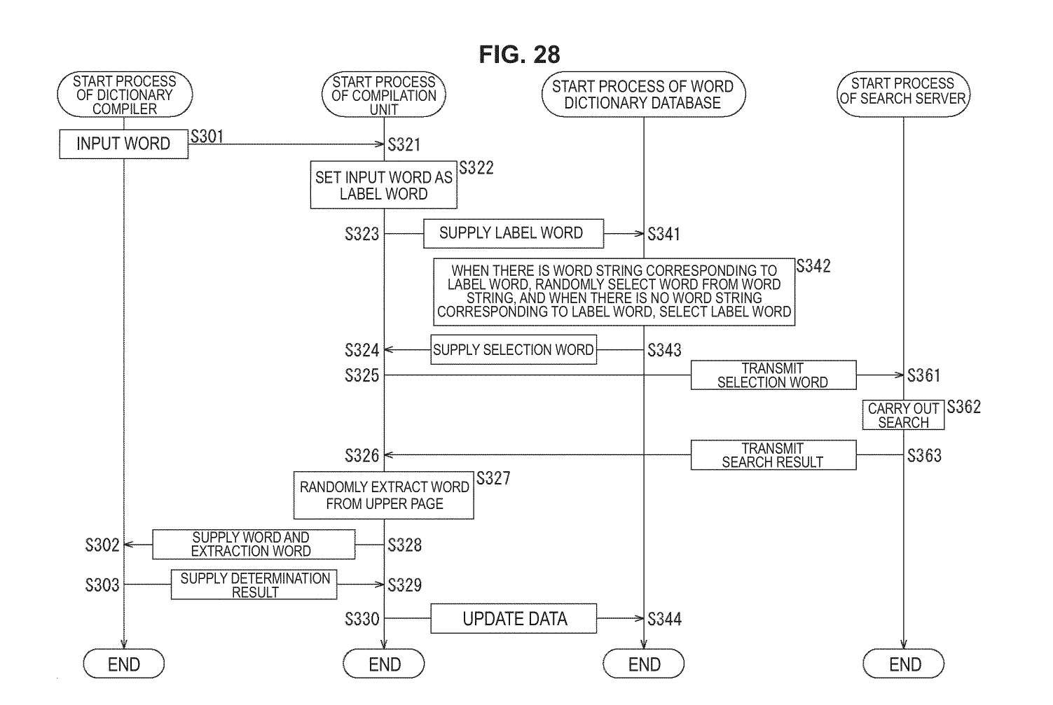

Such a process that is performed to reduce efforts necessary for the dictionary compiler to compile the word dictionary database 22 when the word dictionary database 22 is compiled will be described with reference to a flo tart of FIG. 28.

In step S301, the dictionary compiler inputs a word to be a process target. The word input by the dictionary compiler is supplied to the compilation unit 49 (FIG. 2). The compilation unit 49 acquires the input word having been input by the dictionary compiler in step S321, and sets the input word as a label word in step S322. In other words, the dictionary compiler inputs a label word, and the compilation unit 49 starts searching for words connected with the label word.

In step S323, the compilation unit 49 supplies the set label word to the word dictionary database 22. The word dictionary database 22 acquires the label word in step S341, and searches for whether there is a word string corresponding to the label word in step S342. Here, it is stated that the word dictionary database 22, is supplied with an input word and carries out a search, but the compilation unit 49 can also be configured to search the word dictionary database 22,

When there is a word string corresponding to the label word, in other words, when it is determined that data about the label word considered as a process target has already been registered in the word dictionary database 22, the word string is read out from the data. When the word string is read out, the whole word string may be read out, or a predetermined number of words may be read out.

The reading is assumed to be randomly performed. For example, it is possible to consider a predetermined number of words of high rankings in the word string being read out, or a predetermined number of words of low rankings in the word string being read out, but here, description will continue on the assumption that the reading is randomly performed. In step S342, a predetermined number of words are randomly selected from the word string corresponding to the label word.

In addition, in step S342, a process for a case in which it is determined that there is no word string corresponding to the label word is also performed. In other words, when there is no word string corresponding to the label word, the label word is selected.

The word (hereinafter referred to as a selection word) selected in step S342 is supplied from the word dictionary database 22 to the compilation unit 49 in step S343. When the selection word is acquired in step S324, the compilation unit 49 transmits the acquired selection word to the search server 13 through the Internet 14 in step S325.

The search server 13 acquires the selection word in step S361, and carries out a search in which the selection word is used as a search-target word in step S362. In step S363, the search result is transmitted from the search server 13 to the compilation unit 49. The search result from the search server 13 is, for example, information on a homepage related to the selection word.

In step S327, the compilation unit 49 randomly extracts a word from an upper page. The search result from the search server 13 is a page having a certain relationship with the selection word, such as a page including the selection word, a page in which there is descriptive text about the selection word, or the like. From such a page, a word is randomly extracted.

For this reason, there is a high probability that a word having a relationship with the selection word will be extracted. Also, since the selection word itself is the label word or a word connected with the label word, the randomly extracted word also becomes a word that has a high probability of being connected with the label word.

In step S328, the word that has been randomly extracted by the compilation unit 49 in step S327 is supplied to the side of the dictionary compiler. In step S302, the dictionary compiler receives the supply of the randomly extracted word. This supply is performed by showing a screen, for example, the screen 201 shown in FIG. 27.

For example, at a central portion of the region 332 of the screen 201, a word input by the dictionary compiler, that is, a label word is displayed. Around the label word in the region 332, randomly extracted words are displayed. In FIG. 27, the label word is “softy”, and the randomly extracted words are “general electrical equipment manufacturer”, “Hitachi” (registered trademark), “fish”, “Odakyu” (registered trademark), and “camera”.

In this way, words that have been randomly extracted from a predetermined page are displayed in the region 332 in which unclassified words are displayed. As described above, the words that have been randomly extracted from the predetermined page and displayed in the region 332 have a high probability of being words having a close relationship with a label word. By providing such words to the dictionary compiler, it is possible to save the dictionary compiler itself the trouble of searching for words having a close relationship with the label word, in other words, words displayed in the region 332.

As described with reference to FIG. 27, the dictionary compiler classifies the words displayed in the region 332 into words “including the extraction word” and words “in which the extraction word is included.” The classification results (determination results) are supplied from the side of the dictionary compiler to the compilation unit 49 in step S303. The compilation unit 49 performs an update of data in the word dictionary database 22 in step S330.

For example, when the results are obtained by processing a label word that has already been registered in the word dictionary database 22 as the selection word, the update is performed by adding a new word to the registered label word. Also, for example, when the results are obtained by processing the input word as the selection word, the update is performed by adding new data that has the input word as a label word.

As a pattern of the update, there are the following patterns.

(A) An update is performed by using an extraction word considered to be included in another extraction word as a label word, and an input word as an element of a word string.

(B) An update is performed by using a new addition word considered to be included in an extraction word as a label word, and an input word as an element of a word string.

(C) An update is performed by using an extraction word considered to include another extraction word as an element of a word string, and an input word as a label word.

(D) An update is performed by using a new addition word considered to include an extraction word as an element of a word string, and an input word as a label word.

Among the words displayed in the region 332, unclassified extraction words are discarded. Also, the process may be started by using an unclassified extraction word as a new input word.

When the dictionary compiler feels that there is not sufficient data yet as the classification results, for example, the process of step S327 may be performed again by the compilation unit 49 to randomly extract a word from the upper page and provide the new extraction word to the side of the dictionary compiler. By repeating such a process, a database that satisfies the dictionary compiler is constructed.

By performing a process as described with reference to the flowchart of FIG. 28, it is possible to reduce efforts for a case in which the dictionary compiler compiles the word dictionary database 22.

In the description with reference to FIG. 28, an example in which a search is carried out by the search server 13, and the search results are used has been described. Search results may be obtained not though a search by the search server 13 but through, for example, a search in a database such as a thesaurus or the like. Alternatively, the dictionary compiler can also perform a process of randomly extracting a word from a group of words that have been randomly prepared in advance.

When the search results of the search server 13 are used, it is also possible to perform a process as follows. By using an input word as a keyword, a search is carried out by the search server 13 through the Internet 14, and from a page in which a selection word is most frequently used among a plurality of pages obtained as the results, a predetermined number of words are randomly extracted. At this time, the selection word is set not to be extracted. As described above, it is also possible to perform a process of randomly extracting a predetermined number of words from a page in which a selection word is most frequently used.

In this embodiment, as special words, words below may prompt the user to make a replacement by responding in the following form.

Mail address: @domain is registered in a dictionary.

Postal code: 3-digit number+hyphen+4-digit number.

Place name: according to a place name dictionary.

URL: http or www, registered in a dictionary.

Phone number: a combination of numbers and a hyphen. The number of digits and the like are according to a standard.

Name: according to a biographical dictionary.

Since these words have a high probability of being closely related to individual privacy, it is preferable to prompt replacement of words on a user side with as little omission as possible. Thus, by treating such words as special words differently from other words, it is possible to prompt the user to replace a word.

[Regarding Effects]

Application of the present technology produces the following effects. First, it becomes possible to use existing thesauruses and polyseme dictionaries instead of the word dictionary database 22 for protecting privacy. It becomes possible to suggest more abstracted words in descending order for an input word. By calculating abstraction levels and the like and making a line of words in a word string appropriate in advance, it becomes possible to shorten a time from a user input to a presentation.

In order to match the present technology with an existing input support system, for example, an input support system according to a prediction function, it is not necessary to newly design the whole system, and it is possible to reduce time, cost, process load, and the like necessary for introduction.

Candidates for a replacement candidate word are dynamically displayed for an input word of a user, so that a process of protecting privacy can be simultaneously performed in parallel with sentence making. Through display of candidates for a replacement candidate word, it is possible to cause a user to be aware of a privacy problem,

When there is the problem of privacy, a user can make a replacement with a word having a high abstraction level even by simply selecting a candidate, replace a word related to privacy with another word, and protect privacy. Since a replacement candidate word implies a replacement word, it is possible to make a replacement by which the meaning of a sentence that is being made is not corrupted.

With an increase in the frequency of use of a user, the accuracy of the word dictionary database 22 is improved. The inside of the word dictionary database 22 can be prepared for respective users, and when the inside of the word dictionary database 22 is prepared for respective users, it becomes possible to provide the word dictionary database 22 customized according to the behavior of each user to the user. As a result, it becomes possible to provide the word dictionary database 22 by which it is easier to follow the meaning of a sentence of a user.

Due to an update of a dictionary according to use by a user, the accuracy of the word dictionary database 22 is improved. The word dictionary database 22 can be a database used by a plurality of users in common, and when the number of users increases in such a case, the accuracy of the word dictionary database 22 is further improved in proportion to the increase.

A dictionary compiler can compile the word dictionary database 22 by simply classifying words of a question posed by a dictionary compilation support system that supports compilation of the word dictionary database 22. In this way, it is possible to improve efficiency in compiling the word dictionary database 22.

Since words are extracted from the Internet, it is possible to expand content of the word dictionary database 22. Also, it is possible to compile the word dictionary database 22 independently from the Internet,

It is possible to prevent omission of an item, such as a mail address or the like, that has been formally determined.

In the embodiment described above, an example in which a word related to privacy is replaced with an abstract word has been described. Since words related to privacy are mainly nouns, the above-described process may be limited to be performed on nouns only.

For example, in the compilation of the word dictionary database 22 that has been described with reference to FIG. 27 or FIG. 28, it is possible to reduce the number of words to process by setting nouns as targets. In addition, upon a presentation also, it is possible to limit the speech balloon 101 (FIG. 4 and the like) to pop up from nouns only, and it is also possible to configure an input support process to be performed by using a time when a noun is input as a trigger.

In this embodiment, even if words have a semantic relationship, they are different words, such as a case of replacing a word related to privacy with an abstract word. By using this, this embodiment can be applied to, for example, a case of prompting a replacement of a difficult word with a simpler word.

This embodiment can also be applied to, for example, a case of presenting a speech “having a function necessary for hanging something” together with a message “In plain speech?” when the word “hang” is input. In addition, this embodiment can be applied to a case of not only presenting words as replacement candidates for a word as in the example but also presenting something other than words such as a sentence, a symbol, an expression in another language, and the like.

[Configuration of Personal Computer]

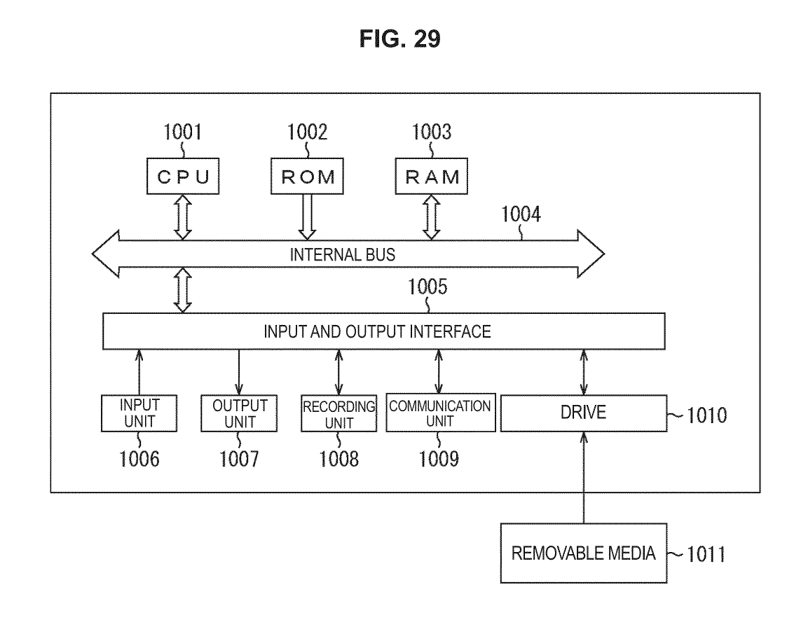

FIG. 29 is a block diagram showing a hardware configuration example of a personal computer that performs the above-described series of processing using a program. In the personal computer, a central processing unit (CPU) 1001, a read only memory (ROM) 1002 and a random access memory (RAM) 1003 are mutually connected by an internal bus 1004.

An input/output interface 1005 is also connected to the internal bus 1004. An input unit 1006, an output unit 1007, a recording unit 1008, a communication unit 1009, and a drive 1010 are connected to the input/output interface 1005.

The input unit 1006 is configured from a keyboard, a mouse, a microphone or the like. The output unit 1007 configured from a display, a speaker or the like. The recording unit 1008 is configured from a hard disk, a non-volatile memory or the like.

The communication unit 1009 is configured from a network interface or the like. The drive 1010 drives a removable media 1011 such as a magnetic disk, an optical disk, a magneto-optical disk, a semiconductor memory or the like.

In the personal computer configured as described above, the CPU 1001 loads a program that is stored, for example, in the recording unit 1008 onto the RAM 1003 via the input/output interface 1005 and the internal bus 1004, and executes the program. Thus, the above-described series of processing is performed.

Programs to be executed by the CPU 1001 are provided being recorded in the removable media 1531 which is a packaged media or the like.

A package media is formed by, for example, a magnetic disc (including a flexible disk), an optical disk (a compact disc read only memory (CD-ROM), a digital versatile disc (DVD) or the like), a magneto optical disk, or a semiconductor memory etc.

The program can also be provided via a wired or wireless transfer medium, such as a local area network, the Internet, or a digital satellite broadcast.

In the personal computer, by loading the removable medium 1011 into the drive 1010, the program can be installed into the recording unit 1008 via the input/output interface 1005.

Further, the program can be received by the communication unit 1009 via a wired or wireless transmission media and installed in the recording unit 1008. Moreover, the program can be installed in advance in the ROM 1002 or the recording unit 1008.

Note that the program executed by the computer may be processes in which processes are carried out in a time series in the order described in this specification or may be a program in which processes are carried out in parallel or at necessary timing, such as when the processes are called.

In the present disclosure, the term “system” means a general apparatus that is configured using a plurality of devices and mechanisms.

It should be understood by those skilled in the art that various modifications, combinations, sub-combinations and alterations may occur depending on design requirements and other factors insofar as they are within the scope of the appended claims or the equivalents thereof. Further, a part of the function of the present embodiment may be held by another apparatus.

Additionally, the present technology may also be configured as below.

(1) An information processing device including:

an acquisition unit that acquires a first word input by a user; and

a presentation unit that presents second words for replacing the first word when the first word is acquired by the acquisition unit.

(2) The information processing device according to (1),

wherein the second words are words obtained by abstracting the first word.

(3) The information processing device according to (1) or (2),

wherein the second words are displayed and presented to the user between a first item manipulated when the first word is used without being replaced and a second item manipulated when a third word different from the first word and the second words is used.

(4) The information processing device according to (3),

wherein the first item, the second words, and the second item are displayed in a speech balloon, and

a tail of the speech balloon is positioned near the first word.

(5) The information processing device according to any one of (1) to (4),

wherein, when the first word has been registered in a database in which the plurality of second words are connected with the first word, the second words are read out and presented to the user.

(6) The information processing device according to any one of (1) to (4),

wherein, when presentation of the second words related to the first word is instructed by the user, the second words are presented.

(7) The information processing device according to any one of (1) to (4),

wherein, when a text string is input, and the text string is converted into the first word, the second words are presented.

(8) The information processing device according to any one of (1) to (4),

wherein, when the first word is selected from a group of words presented by predicting words to be input from input text, the second words are presented.

(9) The information processing device according to any one of (1) to (4),

wherein, when words to be input are predicted from input text, and the first word is included in the predicted words, the second words are presented by displaying the second words to be connected with the first word in a group of predicted words.

(10) The information processing device according to any one of (1) to (4),

wherein, when text is input, words to be input are predicted from the text, a group of the predicted words is presented, and a cursor is positioned on the first word in the presented group of words, the second words are presented.

(11) The information processing device according to (5), further including:

an update unit that updates the database in which the plurality of second words are connected with the first word when the second words are selected, or the third word is input,

wherein the update unit updates a weight indicating a frequency of use of the second words when the second words are selected, and

adds the third word as the second words when the third word is input.

(12) The information processing device according to any one of (5) or (11),

wherein the second words are connected with the first word in a state in which the second words are lined up in descending or ascending order of value calculated according to a predetermined operation expression, and managed in the database.

(13) The information processing device according to (12),

wherein the value is a value indicating, a degree of abstraction of a word.

(14) The information processing device according to (5),

wherein the database is updated and compiled by carrying out a search in which a fourth word serving as the first word is set as a search target,

randomly extracting a word from a page obtained as a search result,

classifying the extracted word according to whether the extracted word includes the fourth word or whether the fourth word is included, and

adding a classification result to the database.

(15) An information processing method of an information processing device including an input unit that receives an input of a user, and a presentation unit that presents information to the user, the method comprising:

acquiring a first word input through the input unit by the user; and

when the first word is acquired, presenting second words for replacing the first word by the presentation unit.

(16) A computer-readable program causing a computer controlling an information processing device including an input unit that receives an input of a user, and a presentation unit that presents information to the user to perform a process comprising:

acquiring a first word input through the input unit by the user; and

when the first word is acquired, presenting second words for replacing the first word by the presentation unit.

It should be understood by those skilled in the art that various modifications, combinations, sub-combinations and alterations may occur depending on design requirements and other factors insofar as they are within the scope of the appended claims or the equivalents thereof.

The present technology contains subject matter related to that disclosed in Japanese Priority Patent Application JP 2012-103553 filed in the Japan Patent Office on Apr. 27, 2012, the entire content of which is hereby incorporated by reference.

What is claimed is:

1. An information processing device comprising:
an acquisition unit that acquires a first word input by a user; and
a presentation unit that presents second words for replacing the first word when the first word is acquired by the acquisition unit.

2. The information processing device according to claim 1,
wherein the second words are words obtained by abstracting the first word.

3. The information processing device according to claim 1,
wherein the second words are displayed and presented to the user between a first item manipulated when the first word is used without being replaced and a second item manipulated when a third word different from the first word and the second words is used.

4. The information processing device according to claim 3,
wherein the first item, the second words, and the second item are displayed in a speech balloon, and
a tail of the speech balloon is positioned near the first word.

5. The information processing device according to claim 1,
wherein, when the first word has been registered in a database in which the plurality of second words are connected with the first word, the second words are read out and presented to the user.

6. The information processing device according to claim 1,
wherein, when presentation of the second words related to the first word is instructed by the user, the second words are presented.

7. The information processing device according to claim 1,
wherein, when a text string is input, and the text string is converted into the first word, the second words are presented.

8. The information processing device according to claim 1,
wherein, when the first word is selected from a group of words presented by predicting words to be input from input text, the second words are presented.

9. The information processing device according to claim 1,
wherein, when words to be input are predicted from input text, and the first word is included in the predicted words, the second words are presented by displaying the second words to be connected with the first word in a group of predicted words.

10. The information processing device according to claim 1,
wherein, when text is input, words to be input are predicted from the text, a group of the predicted words is presented, and a cursor is positioned on the first word in the presented group of words, the second words are presented.

11. The information processing device according to claim 5, further comprising:
an update unit that updates the database in which the plurality of second words are connected with the first word when the second words are selected, or the third word is input,
wherein the update unit updates a weight indicating a frequency of use of the second words when the second words are selected, and
adds the third word as the second words when the third word is input.

12. The information processing device according to claim 5,
wherein the second words are connected with the first word in a state in which the second words are lined up in descending or ascending order of value calculated according to a predetermined operation expression, and managed in the database.

13. The information processing device according to claim 12,
wherein the value is a value indicating a degree of abstraction of a word.

14. The information processing device according to claim 5,
wherein the database is updated and compiled by carrying out a search in which a fourth word serving as the first word is set as a search target,
randomly extracting a word from a page obtained as a search result,
classifying the extracted word according to whether the extracted word includes the fourth word or whether the fourth word is included, and
adding a classification result to the database.

15. An information processing method of an information processing device including an input unit that receives an input of a user, and a presentation unit that presents information to the user, the method comprising:
acquiring a first word input through the input unit by the user; and
when the first word is acquired, presenting second words for replacing the first word by the presentation unit.

16. A computer-readable program causing a computer controlling an information processing device including an input unit that receives an input of a user, and a presentation unit that presents information to the user to perform a process comprising:
acquiring a first word input through the input unit by the user; and
when the first word is acquired, presenting second words for replacing the first word by the presentation unit.
